(19) United States
(12) Patent Application Publication
(10) Pub. No.: US 2023/0061536 A1
(43) Pub. Date: Mar. 2, 2023

(54) PLATING BATH SOLUTIONS

(71) Applicant: SURFACE TECHNOLOGY, INC, Ewing, NJ (US)

(72) Inventors: Jijeesh Thotathil, Mercerville, NJ (US); Michael Feldstein, Princeton, NJ (US); Thomas S Lancsek, Trenton, NJ (US); Doan Nguyen, Ewing, NJ (US)

(21) Appl. No.: 17/755,748

(22) PCT Filed: Aug. 30, 2021
(86) PCT No.: PCT/US2021/048254

§ 371 Date: May 6, 2022

(51) Int. Cl. C23C 18/32; C23C 18/16; C23C 18/18

(52) U.S. Cl. CPC C23C 18/32; C23C 18/1691; C23C 18/1698; C23C 18/1803; C23C 18/1637

(57) ABSTRACT

Compositions for electroless plating baths and their use are disclosed, and more particularly different solutions each usable to both makeup an original bath and to replenishment of the original bath.

### BACKGROUND OF THE INVENTION

Numerous varieties of plating technologies are known in the art. These technologies include electrolytic plating which is also known as electro-plating and by other terms, and electroless plating also known as chemical, autocatalytic and by other terms.

Electroless plating is a well-known and is an established commercial and industrial process for metal plating. The metal portion of the metal salt may be selected from suitable metals capable of being deposited through electroless plating. Such metals include, without limitation, nickel, cobalt, copper, gold, palladium, iron, other transition metals, and mixtures thereof, and any of the metals deposited by the autocatalytic process described in Pearlstein, F., “Modern Electroplating”, Chapter 31, 3rd Ed., John Wiley & Sons, Inc. (1974), which is incorporated herein by reference. Generally, the electroless metal in the deposited coating is a metal, a metal alloy, a combination of metals, or a combination of metals and non-metals. Such coatings are often in the form of a metal, a metal and phosphorous, or a metal and boron. The metal or metal alloy is derived from the metal salt or metal salts used in the bath. Examples of the metal or metal alloy are nickel, nickel-phosphorous alloys, nickel-boron alloys, cobalt, cobalt-phosphorous alloys, and copper alloys. Other materials such as lead, cadmium, bismuth, antimony, thallium, copper, tin, and others can be deposited to form the bath and may be included in the coating.

The salt component of the metal salt may be any salt compound that aids and allows the dissolution of the metal portion in the bath solution. Such salts may include without limitation sulfates, chlorides, acetates, phosphates, carbonates, and sulfamates, among others.

Solutions often include reducing agents, which serve as electron donors. When reacting with the free floating metal ions in the bath solution, the electroless reducing agents reduce the metal ions, which are electron acceptors, to metal for deposition onto the article. The use of a reducing agent avoids the need to employ a current, as required in conventional electroplating. Common reducing agents are sodium hypophosphite, sodium borohydride, n-dimethylamine borane (DMAB), n-diethylamine borane (DEAB), formaldehyde, and hydrazine.

Certain materials may be used in electroless plating baths where these materials serve two or more roles in the plating bath. For example, instead of using the typical combination of nickel sulfate as a metal salt and sodium hypophosphite as a reducing agent, it is possible to use nickel-hypophosphite in an electroless nickel plating bath. Nickel-hypophosphite, however, is very expensive and not widely used commercially due to its impractical cost.

Electroless nickel (EN) is one of the most commercialized varieties of electroless plating. the plating comprises an alloy of nominally 86-99% nickel and the balance with phosphorous, boron, or a few other possible elements. Electroless nickel is commonly produced in one of four alloy ranges: low (1-5% P), medium (6-9% P), or high (10-14% P) phosphorous, and electroless nickel-boron with 0.5-5% B. Each variety of electroless nickel thus provides properties with varying degrees of hardness, corrosion resistance, magnetism, solderability, brightness, internal stress, lubricity, and other properties. All varieties of electroless nickel can be applied to numerous articles, including metals, alloys, and nonconductors.

Electroless composite technology is a more recent development as compared to electrolytic composite technology. The fundamentals of composite electroless plating are documented in a text entitled “Electroless Plating Fundamentals and Applications,” edited by G. Mallory and J. B. Hajdu, Chapter 11, published by American Electroplaters and Surface Finishers Society (1990).

The plating of articles with a composite coating bearing finely dispersed divided particulate matter is well documented. The inclusion of finely divided particulate matter within metallic matrices can significantly alter the properties of the coating with respect to properties such as wear resistance, lubricity, friction, thermal transfer, and appearance.

The co-deposition of particles in composite electroless plating can dramatically enhance existing characteristics and even add entirely new properties. These capabilities have made composite electroless coatings advantageous for a variety of reasons including, but not limited to, increased utility in conditions requiring less wear, lower friction, lubrication, indication, authentication, thermal transfer, insulation, higher friction, and others. Composite electroless coatings with nickel provide an additional environmental advantage over conventional electroless nickel coatings, which do not include particulate matter, in that the particles within composite electroless nickel coatings reduce the amount of nickel alloy used. Such nickel based composite coatings are also an alternative to chromium based coatings which pose certain health and environmental challenges.

Particulate matter suitable for practical composite electroless plating may be from nanometers up to approximately 75 microns in size. The specific preferred size range depends on the application involved.

The particulate matter may be selected from a wide variety of distinct matter, such as but not limited to ceramics, glass, talcum, plastics, diamond (polycrystalline or monocrystalline types, natural or manmade by a variety of processes), graphite, oxides, silicides, carbonate, carbides, sulfides, phosphate, boride, silicates, oxylates, nitrides, fluorides of various metals, as well as metal or alloys of boron, tantalum, stainless steel, molybdenum, vanadium, zirconium, titanium, tungsten, as well as polytetrafluoroethylene (PTFE), silicon carbide, boron nitride (BN), aluminum oxide, graphite fluoride, tungsten carbide, talc, molybdenum disulfide (MoS), boron carbide and graphite. The boron nitride (BN), without limitation, may be hexagonal or cubic in orientation.

For increased friction on the surface of a resultant coating and/or increased wear resistance, hard particulates, such as but not limited to diamond, carbides, oxides, and ceramics, may be included in the plating bath. Application of an overcoat of a conventional plated layer on top of the composite plated layer is also done in the field in order to further embed the particulate matter within the coating.

For increased lubrication or reduction in friction in the resultant coating, “lubricating particles,” such as polytetrafluoroethylene (PTFE), boron nitride (BN), talc, molybdenum disulfide (MoS), graphite or graphite fluoride among others may be included in the plating bath. These lubricating particles may embody a low coefficient of friction, dry lubrication, improved release properties, and/or repellency of contaminants such as water and oil.

For light emitting properties in the resultant coating, particulates with phosphorescent properties such as, but not limited to, calcium tungstate may be included in the plating bath.

For identification, authentication, and tracking properties in the resultant coating, various particulate and solid materials may be included in the plating bath so they will be incorporated into the coating and detectable either visually, under magnified viewing, or detection with a suitable detector

The inclusion of insoluble particulate matter in composite electroless baths introduces additional instability. To overcome the extra instability due to the addition of insoluble particulate matter to the bath, such as described in U.S. Pat. No. 6,306,466, the general use of particulate matter stabilizers (PMSs) is believed to isolate the finely divided particulate matter, thereby maintaining the particular matter's “inertness”. Such PMSs are well-known, and include, without limitation, sodium salts of polymerized alkyl naphthalene sulfonic acids, disodium mono ester succinate (anionic and nonionic groups), fluorinated alkyl polyoxyethylene ethanols, tallow trimethyl ammonium chloride, and any of the PMS disclosed in U.S. Pat. No. 6,306,466, which is incorporated herein by reference.

The electroless metallizing bath may also contain one or more complexers, also known as complexing agents. A complexing agent acts as a buffer for reasons which may include pH control and maintaining control over the “free” metal salt ions in the solution, all of which aids in sustaining a proper balance in the bath solution.

The electroless metallizing bath may further contain a pH adjuster to also help control pH levels in the bath. Suitable pH adjusters may buffer the plating bath at a desired pH range.

Some materials may serve one or more functions within an electroless plating bath. For example, ammonium hydroxide is both a pH adjuster as well as a complexer; cadmium, aluminum, copper and others materials are both a stabilizer and a brightener, lactic acid is both a complexer and a brightener, some sulfur compounds like thiourea are both stabilizers and accelerators depending on concentration, and there are other multipurpose ingredients useful in electroless plating baths.

Ingredients typical in electroless plating and useful in the present invention include, but are not limited to the following materials in the following general categories:

Complexers

Acetic Acid, Alanine-beta, Aminoacetic Acid, Ammonium Bicarbonate, Ammonium Carbonate, Ammonium Chloride, Ammonium Hydroxide, Boric Acid, Citric Acid, Citrates, EDTA, Ethylenediamine, Fluoboric Acid, Glycerine, Glycine, Glycolic Acid, Glycolic Acid Salts, Hydroxyacetic Acid, Lactic Acid, Maleic Anhydride, Malic Acid, Malonic Acid, Orthoboric Acid, Oxalic Acid, Oxalic Acid Salts, Propionic Acid, Sodium Acetate, Sodium Glucoheptonate, Sodium Hydroxyacetate, Sodium Isethionate, Sodium or Potassium Pyrophosphate, Sodium Tetraborate, Succinic Acid, Succinate Salts, Sulfamic Acid, Tartaric Acid, Triethanolamine, Monocarboxylic Acids, Dicarboxylic Acids, Hydrocarboxylic Acids, Alkanolamines, and combinations and variations of such materials.

Stabilizers

2 Amino-Thiazole, Antimony, Arsenic, Bismuth Compounds, Cadmium Compounds, Lead Compounds, Heavy Metal Compounds, Iodobenzoic Acid, Manganese Compounds, Mercury Compounds, Molybdenum Compounds, Potassium Iodide, Sodium Isethionate, Sodium Thiocyanate, Sulfur Compounds, Sulfur Containing Aliphatic Carbonic Acids, Acetylenic Compounds, Aromatic Sulfides, Thiophenes, Thionaphthalenes, Thioarols, Thiodipropionic Acid, Thiodisuccinic Acid, Tin Compounds, Thallium Sulfate, Thiodiglycolic Acid, Thiosalicylic Acid, Thiourea, and combinations and variations of such materials.

Brighteners

Aluminum, Antimony Compounds, Cadmium Compounds, Copper, Lactic Acid, and combinations and variations of such materials.

pH Controllers

Ammonium Bicarbonate, Ammonium Carbonate, Ammonium Chloride, Ammonium Hydroxide, Potassium Carbonate, Potassium Hydroxide, Sodium Hydroxide, Sulfamic Acid, Sulfuric Acid, and combinations and variations of such materials.

Particulate Matter Stabilizers (Dispersants, Surfactants, Wetters)

Sodium salts of polymerized alkyl naphthalene, disodium mono ester succinate (anionic and nonionic groups), fluorinated alkyl polyoxyethylene ethanols, tallow trimethyl ammonium chloridesulfonic acids, disodium mono ester succinate (anionic and nonionic groups), fluorinated alkyl polyoxyethylene ethanols, tallow trimethyl ammonium chloride, and any of the PMS disclosed in U.S. Pat. No. 6,306,466, which is incorporated herein by reference, and combinations and variations of such materials.

Buffers

Borax, Boric Acid, Orthoboric Acid, Succinate Salts, and combinations and variations of such materials.

Reducing Agents

DMAB, DEAB, Hydrazine, Sodium Borohydride, Sodium Hypophosphite, and combinations and variations of such materials.

Accelerators

Fluoboric Acid, Lactic Acid, Sodium Fluoride, Anions of some mono and di carboxylic acids, fluorides, borates, and combinations and variations of such materials.

Metal Salts

Cobalt Sulfate, Copper Sulfate, Nickel Sulfate, Nickel Chloride, Nickel Sulfamate, Nickel Acetate, Nickel Citrate, and combinations and variations of such materials.

Historically electroless nickel and composite electroless plating processes have included heavy and/or toxic metals in the plating bath to overcome the inherent instability of the plating bath. Lead has been the most commonly used material to serve this purpose. Cadmium has also been used widely over the years as a brightener for electroless nickel coatings. But this incorporation of heavy metals into the plating baths presents multiple challenges. The heavy metals must be added in a sufficient amount to prevent the decomposition of the plating bath, but an increased concentration beyond the necessary level required to prevent the decomposition results in cessation or reduction of the plating rate. Increasingly stringent rules and regulations that restrict or prohibit the use of heavy metals, such as the Removal of Hazardous Substances (RoHS) and End-Of-Life Vehicle (ELV) Regulations. However, U.S. Pat. Nos. 7,744,685 and 8,147,601 disclose stable composite electroless nickel plating baths without the use of heavy and/or toxic metals. These patents are included herein by reference.

Because the present invention is directed to various improvements over the prior art, the electroless nickel and composite electroless nickel solutions of the present invention may contain heavy metals or may be essentially free of heavy metals, which means that no such heavy metal is added to the plating bath and/or the heavy metal concentration should be no more than a level that would cause the coating on articles plated in said bath to have a heavy metal concentration in excess of any relevant regulations. The solutions of the present invention may also contain heavy metals less toxic and/or subject to fewer regulations than lead, cadmium and others.

In recent years, there has been a growing desire within the plating industry to avoid the use of ammonium hydroxide. Ammonium hydroxide is an effective non-heavy metal and very strong complexing agent and also a pH adjuster. Ammonium hydroxide, however, is objectionable to some plating shops due to environmental, health, and/or safety regulations, and also because of smell, and the difficulty it causes in the ability to remove the nickel from the plating bath at the end of the bath's life. Storage and handling of ammonium hydroxide is also problematic as it can cause storage drums and other containers to bloat, it emits a very noxious odor experienced when opening a container, pumping, and being transported, and causes a strong reaction when added to a hot plating bath unless the extra step of diluting the ammonium hydroxide by 50 percent by volume or more is performed in advance. Specially designed respirators are needed when handling ammonium hydroxide. It is therefore desirable to have a solution for an electroless nickel plating bath where this solution is free of ammonium hydroxide, and whereby the user or plater has the ability to use a chemical other than ammonium hydroxide as an auxiliary solution to maintaining the pH of the plating bath during usage.

In recent years, there has been a growing desire within the plating industry to use lower concentrations of metal salts in the plating baths. The primary justifications for this alternative to the conventional concentrations of metal salts in the plating baths are to 1) reduce the drag out of the metal salts from the plating baths to the subsequent rinse tanks and thereby reduce the amount of metal salts that need to be captured in subsequent waste treatment of the rinse water facilitating better environmental practices, 2) reduce the amount of metal salts that are essentially wasted when the plating bath comes to the end of its useful life and the bath is waste treated or otherwise disposed of, 3) improve the quality of the plating by lowering the amount of metal salts in the bath which have the potential to precipitate or react in the bath in ways other than the desired reduction and deposition onto articles immersed in the plating bath for the purpose of plating, especially effective in reducing shelf roughness, 4) lowering the cost to makeup a plating bath, 5) extend plating bath life, especially when plating onto aluminum substrates, 6) increase reducing agent efficiency, and 7) contain less metal and other substances in the mist emanating from the plating bath. An example of this practice is in the electroless nickel plating field where some platers are using plating baths with less than the traditional 6 grams per liter of nickel metal in the bath, for example, 3 grams per liter. The background and justification for using electroless nickel plating baths with reduced nickel content is well documented in: http://www.pfonline.com/articles/fifth-generation-reduced-ion-electroless-nickel-systems. When applied to electroless nickel plating systems, the present invention, which is directed to various improvements over the prior art, is able to operate effectively at a traditional concentration of 6 grams per liter of nickel metal in the plating bath, 3 grams per liter of nickel metal in the plating bath, and other concentrations. Formulation of the solution useful for makeup and replenishment of an electroless nickel plating bath according to the present invention, but using less than the amount of a metal salt required to yield the traditional 6 grams per liter of nickel metal in the plating bath, has the benefit of reducing the quantity of ingredients in the solution and thereby making the solution easier to formulate and concentrate.

In addition, in recent years, health and environmental concerns have been raised about the inclusion of certain materials such as perfluorooctane sulfonate (PFOS) and perfluorooctanoic acid (PFOA) that may be used in plating systems, including composite plating systems, including those with PTFE. PFOS may be contained in certain particulate matter stabilizers (PMSs) useful for electroless plating. The present invention, directed toward improvements over the prior art, therefore includes compositions, baths, and methods for plating that may contain PFOA and/or PFOS, or may be free, or have only trace amounts of PFOA and/or PFOS.

While many elements of the EN plating chemistry, process, and industry have evolved, one essential methodology related to the technology has remained relatively unchanged since the early style baths were surpassed by formulations that were easier and more reliable to operate. This method includes initial makeup and to subsequently maintain the EN plating bath. Makeup of an EN bath involves combining the ingredients required to create a bath that is ready to be used for its intended purpose. Maintenance, also known as replenishment for this type of bath, of the EN bath involves replacing the chemical elements of the bath that have been depleted from the bath as plating occurs from the bath onto articles immersed in the bath or otherwise spent.

While it is possible to makeup and replenish a plating bath by adding the desired amount of each individual ingredient to form a solution, the established method to makeup and replenish a plating bath is to combine three or more separate pre-made solutions with water.

When three solutions are used, it is common in the field to makeup an EN bath with an “A” solution, a “B” solution, and water. The A solution typically contains the metal salt (for example, nickel sulfate), and may contain other ingredients, and accounts for five to six percent of the volume of the plating bath. The B solution typically contains the reducing agent (for example, sodium hypophosphite), other functional ingredients like stabilizers, brighteners, pH buffers, chelators, complexing agents, accelerators, particulate matter stabilizers, etc., and accounts for fifteen to twenty percent of the volume of the plating bath. Keeping materials separated from one another—like separating the metal salt from the reducing agent—precludes the initiation of the chemical process whereby the metal separates and complexes or reduces. The balance, typically about eighty percent of the volume of the plating bath, is made up of water plus the possibility of an acid or base to adjust the pH of the EN bath before it is heated to the desired temperature and used for plating. The water is typically deionized water. That is, the initial bath is comprised of the A solution, the B solution, water, and potentially a pH adjuster, where the pH adjuster may be introduced into the water before being combined with A and B.

The use of multiple plating compositions for formulating a bath, as described herein, is referred to as a “plating bath system”.

As the bath is used, its contents need to be replenished. An EN bath is typically replenished with the A solution as well as a “C” solution. The C solution is typically similar to the B solution, containing the reducing agent (for example, sodium hypophosphite), other functional ingredients like stabilizers, brighteners, pH buffers, chelators, complexing agents, accelerators, particulate matter stabilizers, etc., but the specific combination and concentration of these chemicals are in different concentrations in the C solution than they are in the B solution. The reason for the difference of concentrations of these chemicals is the difference in the consumption or depletion rate of each material from the initial makeup concentration due to the plating reaction. C solutions are typically formulated to be used in a convenient ratio for replenishment relative to the A solutions, for example one part A solution plus two parts C solution; or for example one part A solution plus one part C solution.

First, the need to use multiple solutions for bath makeup and replenishment involves significant logistics, including shipping, storage, labeling, material safety data sheets (MSDS) and other product information. These excessive logistics add complexity to the manufacturer of the solutions, any distributors that may be involved, transportation companies, compliance companies, emergency response organizations, and naturally the end user of the solutions.

Second, the use of multiple solutions requires the packaging and shipping of excess water. This causes excessive packaging materials such as totes, drums, buckets, etc. It also causes excess shipping of water that means higher costs to the manufacturer and end user, as well as a waste of energy by the transport company.

Third, the use of multiple solutions increases the opportunity for error by the end user. There exists the opportunity, as is known to occur periodically, for an end user to mistakenly use a C solution during bath makeup instead of the correct B solution, or mistakenly use a B solution for replenishment of a bath instead of the correct C solution. When these mistakes occur, made more likely by the presence of multiple solutions, the composition of the bath will certainly be out of balance, and there is a strong likelihood that the bath will be rendered useless for proper plating.

Fourth, even though the manufacturers of solutions to be used by platers formulate their solutions to work in relatively convenient formulations so they can be used in a certain ratio, these practices and the formulations still have shortcomings. A typical plating system may use A, B, and C solutions whereby the bath is made up with 5% by volume of the A solution plus 15% by volume of the B solution plus water as the balance. Such baths are then typically replenished during use with a ratio of 1 part of the A solution to 2 parts of the C solution. This means that one metal turnover (MTO) would involve the cumulative addition of another 5% by volume of the A solution plus 10% by volume of the C solution. The shortcoming of this system is that while the solutions are formulated for use in this or another designated ratio, in practice, it is difficult for many platers to accurately make the required additions of the multiple solutions so as to assure proper ratios and pH. Use of improper ratios or pH can impact the coverage of the article being plated as well as have other non-desirous consequences. Through manual pouring/measuring of the individual solutions and adding each to the bath, there are numerous opportunities for the user to add the wrong amount of one or more of these solutions and thereby cause the ingredients in the plating bath to become out of balance, which can lead to one or more of the problems in the plating bath, and/or the plating disclosed in the course of this present invention, and/or possibly, the need to dispose of the bath unnecessarily prematurely. While some platers use automated pumping systems to make the additions of the replenishment solutions, and some include automated analysis equipment to determine the quantities of replenishment solutions required, malfunctions and other issues can occur which can lead to the wrong amount of one or more of these solutions being added to the plating bath and thereby cause the ingredients in the plating bath to become out of balance.

Fifth, when using multiple solutions for the makeup and/or replenishment of a plating bath, there exists an opportunity for contamination of one solution to the next if pumps, containers, and the like are shared between two or more of the solutions.

When more than two solutions are used, such as the Addplate™ concentrate systems sold by Surface Technology, Inc. of Ewing, N.J., it is common in the field to make up an EN bath with a plurality of solutions such as 1) an “M” solution, 2) a solution of nickel sulfate, and 3) a solution of sodium hypophosphite, plus water. The M solution typically contains functional ingredients like stabilizers, brighteners, pH buffers, chelators, complexing agents, accelerators, particulate matter stabilizers, etc., and accounts for eight to ten percent of the volume of the plating bath. The remaining solutions—a nickel sulfate and a sodium hypophosphite solution—typically account for four and a half percent each of the volume of the plating bath. The balance, typically about eighty-two percent of the volume of the plating bath, is made up of water plus the possibility of an acid or base to adjust the pH of the EN bath before it is heated to the desired temperature and used for plating. The water is typically deionized water. The EN bath is then typically replenished with an “R” solution as well as the nickel sulfate and sodium hypophosphite solutions. The R solution is typically similar to the M solution, containing functional ingredients like stabilizers, brighteners, pH buffers, chelators, complexing agents, accelerators, particulate matter stabilizers, etc., but the specific combination and concentrations of these materials are in different concentrations in the R solution than they are in the M solution. The reason for the difference of concentrations of these materials is due to the difference in the consumption or depletion rate of each material from the plating bath during usage of the plating bath and the plating reaction. The R solutions are formulated to be used in a convenient ratio to the nickel sulfate and sodium hypophosphite solutions, for example one part nickel sulfate solution plus one part sodium hypophosphite solution plus one part R solution; or for example one part nickel sulfate solution plus one part sodium hypophosphite solution plus one half or one third part R solution.

We are aware of that some companies in the plating industry that have offered and/or used systems where the bath can be made up of one single component instead of two, three or more. But in these systems it is not possible to replenish that same bath with the same makeup solution for ongoing maintenance of the bath over the bath's life while providing proper bath stability and plating quality or being usable at high volumes.

It is possible, especially as would be evident to one skilled in the art, to operate an electroless plating bath with one component solution used alone to makeup the plating bath and a second component solution used alone to replenish the plating bath. Such a two component system still lacks the full utility of the single component of the present invention.

When discussing the materials and solutions used in the makeup and replenishment of electroless plating baths, and if the system is a one, two, three, four or more solution system, it is customary in the field to count the number of solutions containing the primary functional ingredients such as metal salts, reducing agents like stabilizers, brighteners, pH buffers, chelators, complexing agents, accelerators, particulate matter stabilizers, etc., and mixtures thereof, as understood by practitioner in the field and other persons of ordinary skill in the art. The addition of any other ingredients to the plating bath is not considered an additional solution. For example, the addition of materials such as ammonium hydroxide, other hydroxides, carbonates and the like to adjust the pH of the plating bath is not considered a solution in the same way as a typical A, B, C, M, or R solution is counted in the system. These materials are considered auxiliary solutions. Solutions of additional stabilizers, brighteners, accelerators, PMSs, and other materials may also be used as auxiliary solutions to modify the plating bath for specific purposes, often for episodic purposes rather than consistent uses. If such materials were needed for consistent, routine purposes in the plating bath, they might be incorporated into one or more of the primary solutions such as the A, B, C, M, or R solutions. Similarly, the addition of particulate matter, in powder, liquid dispersion, or other form, is also considered an auxiliary material or solution, and is not considered a solution or component in the same way as a typical A, B, C, M, or R solution is considered as a solution in the system.

Consequently, it would be beneficial for a single solution usable for both initial/makeup and replenishment purposes.

The typical operation of an electroless plating bath consists of the following steps. First, a plating bath is made up traditionally as already discussed in this disclosure. The plating bath is then heated by any of a number of mechanisms to reach a desired operating temperature. Articles for plating may be cleaned and otherwise pretreated according to their base metal(s) and condition, and immersed into the plating bath. While the articles are being plated for a time commensurate with the plating rate of the plating bath and the desired thickness of the plating onto the articles, the temperature and pH of the plating bath are typically monitored and maintained at desired levels. During or after the plating of the articles, the plating bath is analyzed to determine the amount of certain components in the plating bath. Typically this analysis is intended to determine the metal content of the metal salt remaining in the plating bath, and this is accomplished by wet chemistry or by instrumental analysis. Knowing the present metal content allows one to determine how much additional metal salt and other chemicals are needed. Based on the concentration of this metal in the plating bath, the plating bath is traditionally replenished with two or more solutions containing the ingredients needed to replace what has been depleted through the plating process. This replenishment can be added to the plating bath by pouring, pumping, or other means. Analysis of other individual components, such as reducing agents and stabilizers, in the plating bath can be accomplished but is much less common, and therefore increases the potential for the ratio of ingredients to become imbalanced with the metal salt and other ingredients in the plating bath. This represents one further advantage of the present invention whereby the ingredients will remain in the proper ratio as they are all contained in the single primary component used for makeup and replenishment of the plating bath.

### BRIEF DESCRIPTION OF THE PRESENT INVENTION

The present invention is directed to a family of compositions (often referred to herein as “solutions”) for electroless plating baths, the baths themselves, their use, and the resultant plated articles, wherein each of the solutions is usable as both an initial or makeup solution for bath formulation as well as a solution for replenishment. When used for both purposes, the composition of the solution is identical.

The present invention is directed to a plating solution mixture, at times in concentrate form, usable as a single solution for both makeup and replenishment which is also commercially useful and viable.

Commercial viability means the performance of the solution and the plating bath resulting from the solution are consistent with or better than the state of the art before the present invention in plating based on factors including, but not limited to, economy of use, energy use, environmental considerations, lifetime, plating rate, coating quality, safety, and stability in storage, transport, and use,

The present invention is further directed to a single solution useful for the makeup and replenishment of a plating bath which is useful and economical on a commercial basis. The present invention is further directed towards a single solution that is useful for the makeup and replenishment of a plating bath that is capable of producing plating performance and coatings that are free of problems in the deposit being created consequential to the solution. Such problems include, but are not limited to skip plating, pitting, edge pull-back, step plating, dark or laminar deposit, roughness in deposits, streaks in deposit, dull or matte deposits, poor adhesion of the deposit to the substrate, poor corrosion and/or chemical resistance of the deposit.

The present invention is further directed to a plating solution mixture and a method for electroless plating whereby a single solution is usable for both makeup and replenishment of the same bath. In one embodiment, the present invention includes a plurality of complexers with intentionally varying stability constants or intentionally varying other factors. In one embodiment the solution is free of fluorides and/or fluorocarbons. In one embodiment, the solution of the present invention avoids the use of heavy and/or toxic metals. In one embodiment, the solution provides full functionality for plating even after being exposed to a variety of environmental conditions while in transport and/or storage, such as but not limited to temperature extremes. In one embodiment, the solution can be used as a concentrate for a bath. In one embodiment, the solution includes any of a variety of particulates and potentially stabilizers for particulates. In one embodiment, the solution is used in a bleed and feed method. In one embodiment, the solution is void of thiourea. In one embodiment, the solution includes metal at a low density. In one embodiment, the solution is at a pH consistent with the pH of the associated bath.

In this application, the terms “makeup” and “initial” are used interchangeably.

In this application, the terms “coating” and the noun “plating” are used interchangeably.

In one preferred embodiment of the present invention, the sole solution useful for both the makeup and replenishment of an electroless plating bath contains one or more of the following ingredients: metal salt, reducing agent, complexer, pH adjuster, and stabilizer.

The present invention is further directed towards a single solution that is useful for the makeup and replenishment of a plating bath where the solution is stable at high and low temperatures for increased stability and practicality in manufacture, transport, and storage. This stability can be derived from the selection of ingredients as disclosed herein.

The present invention is further directed to a low metal system of plating, where the operator of the plating process need not excessively monitor the concentration of metal in the bath. In addition, replenishment is much quicker using the one component solution of the present invention. In addition, because of the use of a single component instead of the traditional plurality of components, an operator can employ a small pump arranged for continuing replenishment and avoid manual replenishment completely. Such a pump may be automated or not. Such a low metal bath limits manual interaction with the bath and keeps concentration and performance at or near optimal levels, thereby assuring improved plating.

The present invention is further directed to an embodiment with coatings of up to 30% PTFE, and coatings which are RoHS (and comparable) compatible, no PFOS, and/or no PFOA. In at least some embodiments, the coating includes both PTFE and nickel as a composite.

The present invention is further directed to extending bath life with limited interaction in monitoring a bath.

The present invention is further directed towards a single solution that is useful for the makeup and replenishment of a plating bath where the plating bath is stable for use for a multitude of metal turnovers and for a multitude of days in a plating tank with no maintenance or only a commercially acceptable amount of maintenance of the tank, heaters, pumps, filters, and/or other auxiliary equipment associated with the plating tank so as to achieve commercially adequate plating. The present invention is further directed towards a single solution that is useful for the makeup and replenishment of a plating bath where the plating bath is stable for composite plating, where particles in the plating bath may tend to destabilize the plating bath as particles embody surface area in the plating bath that can affect its stability.

Stable in solution means that the solution remains viable for plating while in solution and does not precipitate, disassociate, the nickel doesn't complex to the point of unusability, or have any reaction whereby plating would be impacted adversely.

The present invention is further directed towards a single solution that is useful for the makeup and replenishment of a plating bath where the solution can makeup a plating bath at a variety of metal concentrations such as but not limited to 3-6 g/l.

The present invention is further directed towards a single solution that is useful for the makeup and replenishment of a plating bath for plating electroless nickel with PTFE with a low metal concentration in the plating bath to reduce the cost and material waste of the plating bath.

The present invention is further directed towards a single solution that is useful for the makeup and replenishment of a plating bath for plating electroless nickel with PTFE without fluorinated surfactants or, at least in some scenarios, no fluorine or fluorinated components at all.

The present invention is further directed toward concentrates useful to form the type of solutions disclosed herein, and thereby provide additional options and benefits for manufacture, storage, transportation, and use of said concentrates and solutions.

The present invention is further directed toward concentrates useful to make up and maintain plating baths concurrently with one or more other materials, and thereby provide additional options and benefits for manufacture, storage, transportation and use of said concentrates and solutions.

The present invention is further directed towards a single solution that is useful for the makeup and replenishment of a plating bath where a portion of said plating bath may be removed after plating one or more articles and replaced with a portion of a newly formed plating bath in a commercially useful manner.

The present invention is further directed to processes and product related to a single solution for both the make-up and replenishment of an electroless plating bath.

The present invention is able to operate effectively with or without ammonium hydroxide. The present invention is able to operate effectively with sodium hydroxide, potassium hydroxide, potassium carbonate, and the like as pH adjusters within the solution of the present invention or as auxiliary additives to affect the pH of the plating bath made with the solution of the present invention.

Though the present invention primarily focuses on some defined electroless plating systems, other plating systems also fall within the spirit and intent of this invention. Other examples include, but are not limited to: all electroless plating baths, all electroless nickel plating baths including any content of phosphorous and/or boron, poly alloy plating baths, electroless cobalt plating baths, EN systems with different levels of brightness, EN plating that is subsequently blackened, plating systems stabilized with heavy metals, toxic, non heavy metals, non toxic metals, or no metals, plating baths including nickel hypophosphite, composite plating systems, electroless cobalt, copper, palladium, gold, and/or silver plating baths, plating baths that are made up with or without ammonium hydroxide, plating baths that may be replenished and maintained with or without ammonium hydroxide, plating baths that are made up with or without ammonium hydroxide, and plating baths that may be replenished and maintained with or without ammonium hydroxide.

The present invention encompasses all varieties of baths used for electroless nickel coatings with varying concentrations or freedom from various materials such as, but not limited to, lead, cadmium, heavy metals, toxic metals, PFOA, PFOS and others that are subject of environmental and related regulations such as Restriction of Hazardous Substance Directive (RoHS), Directive on Waste Electrical and Electronic Equipment (WEEE), End of Life Vehicle Directive (ELV), Registration, Evaluation, Authorisation, and Restriction of Chemicals (REACH), and the like.

In describing the present invention's directions and preferred embodiments, specific terminology will be resorted to for the sake of clarity. However, the invention is not intended to be limited to the specific terms so selected, and is to be understood that each specific term includes all technical equivalence which operate in a similar manner to accomplish a similar purpose.

A functional benefit of the present invention includes cost and efficiency savings resulting from use of a single composition for bath initiation and replenishment.

### BRIEF DESCRIPTION OF THE FIGURES

FIG. 1 shows a table (Table 1) of pK factors associated with nickel-ligand complexes.

FIG. 2 includes a chart (Table 2) showing various combinations of components and their concentrations and operating ranges in single solutions of the present invention.

### DETAILED DESCRIPTION OF THE PRESENT INVENTION

The present invention is directed to a single solution useful for the makeup and replenishment of a plating bath, where the bath is useful and economical on a commercial basis, as well as to the solution's and the bath's use.

The present invention is useful on a commercial basis as it solves problems including those associated with prior products and practices in the field. The utility of the present invention is superior to plating systems requiring multiple solutions and earlier attempts at a single solution, pre-present invention plating system, for example the Enplate NI-416 system of Enthone Incorporated, from 1975, which claimed to be able to operate with either a single solution for lower performance or as a three solution system for higher performance, where lower performance was defined as limited use, inappropriate for high volume and commercial applications. In contrast, the present invention is a single, high performance product with intent for commercial use. An earlier version of the present product is commercially useful today as demonstrated by actual widespread use in the plating industry. The present invention improves upon the earlier product in several ways.

Unlike the earlier version of the present product, the present invention is stable at hot and cold temperatures for transportation and storage, whereas the literature associated with the Enplate NI-416 system does not indicate stability (stability was a known drawback at the time) at hot or cold temperatures for transport and storage, which is necessary for practical use and commercial viability. We believe it was not stable, based on our extensive testing of plating solutions. But for other reasons described herein, the present invention is superior to and therefore distinct from both NI-416 and earlier versions of the present product.

The present invention is viable for commercial use including high volume and consistent use, whereas the NI-416 operating instructions state the opposite—that when the process is run as a single component system, it is best for low volume or occasional use.

The present invention includes solutions used for a wide array of plating systems including low, medium, and high phosphorous electroless nickel and composite electroless nickel, all possible with a variety of ingredients, metal concentrations, stabilizers to meet (Restriction of Hazardous Substances) RoHS, (End of Life Vehicles) ELV, Waste from Electrical and Electronic Equipment) WEEE, Registration, Evaluation, Authorisation and Restriction of Chemicals (REACH) and other similar regulations regarding toxicity and disposal, and other pertinent factors as detailed in this disclosure.

According to Enplate literature, the NI-416 includes a family of related products, no one of which serves the purpose of the present invention. The EN-416M product was defined to provide only for a low number of metal turnovers (two or three) when used as a single component system, which certainly is not practical for commercial use and is far lower than any product of the present invention provides. Presumably for that reason the company lists two alternative products, Enplate NI-416R and Enplate NI-416S, which are to be used together (not a single solution) to replenish a plating bath that was initially made up with EN-416M. That is, there was no product that can be used (1) for makeup and replenishment (2) for high volume operation (3) as a single solution. The present invention solves this problem with a single solution that is able to achieve a high and commercially viable number of metal turnovers.

The solution of the present invention can be used at 10% by volume or less to make up a plating bath. The Enplate NI-416M solution is used at a 33% by volume of the bath. That is much higher than the present invention any other commercial electroless nickel system in the industry. This also would render the Enplate NI-416M solution not viable for commercial use due to the high cost to manufacture, transport, storage, and use in a commercial application compared to the present invention.

According to the operating instructions, the NI-416 system operates at 6.75-9.0 grams per liter of nickel metal. This high concentration use is not commercially viable in the electroless nickel industry where 6 grams per liter has been the most established upper limit of nickel concentration in commercial applications and had been for decades. A preferred embodiment of the present invention operates at just 5 grams per liter or less of nickel metal in the plating bath to provide cost, convenience, and environmental benefits.

The Enplate EN-416 system operating instructions emphasize that the plating bath should be kept above 95% concentration of the nickel metal and other ingredients. That equals at least 7.8 g/L of nickel metal in the bath from their optimal nickel metal concentration, which is challenging to maintain in commercial practice, and therefore not commercially viable. Such a high concentration requires frequent replenishments with reductions in other chemicals as compared with the initial solution. Also, the higher nickel metal concentration in the plating bath is more costly for companies to use and inherently means an excess amount of nickel and other materials are disposed of unnecessarily and expensively at the end of the bath life.

The NI-416 operating instructions state that when the three component version of the system is used, the bath maintains its own pH through normal replenishment. But when the single component version of the system is used, the bath does not maintain its own pH through normal replenishment and ammonium hydroxide additions are necessary. This suggests (1) that there may not be a pH adjuster in Enplate NI-416M as there is in the solution of the present invention and (2) the NI-416 solution is not really a single solution at all. Importantly, the operating instructions for the NI-416 system do not disclose or suggest complete formulation composition.

The present invention meets previous unmet needs of the aforementioned extinct product and others in the field by a) the specific composition of ingredients of the present invention, b) that particulate matter as can be used in the present invention for composite plating, c) the ability to operate free of ammonia, d) that articles plated in the present invention can conform to various regulations in today's plating industry such as RoHS, ELV, WEEE, and the like, and e) that the plating bath can be operated a less than 6 grams per liter of nickel metal as is possible with the present invention.

The present invention is directed to a single solution and its use for both makeup and replenishment of the same electroless plating bath, thereby replacing the two, three, or four solution systems traditionally used in the field. Auxiliary solutions may still be used with the single solution of the present invention, similarly to how they may be used in the prior art systems with two, three, four, or more solutions.

The present invention is also directed to a bath using the aforementioned solution as well as plated articles plated using the aforementioned solution, in addition to methods of use, such as but not limited to plating methods and bath operation methods.

Though the present invention primarily focuses on electroless nickel phosphorus plating systems, other plating systems fall within the spirit and intent of this invention. Other relevant examples of systems and baths include, but are not limited to:
All electroless plating baths
All electroless nickel plating baths
All nickel-phosphorous alloy ratios
Electroless nickel-boron
Poly alloys
Electroless cobalt
EN systems resulting in different levels of brightness
EN plating that is subsequently blackened
Non-metal stabilized plating systems
Metal stabilized plating systems
Heavy metal stabilized plating systems
Composite plating systems
Electroless copper, palladium, gold, and/or silver
Alloys/combinations thereof.

The solution of the present invention may contain some quantity of one or more of the materials that are ordinarily added to the plating bath as auxiliary solutions. For example, it is within the scope of the present invention to have a single solution used for the makeup and replenishment of the plating bath where the solution contains insoluble particulate matter, and additional quantities of particulate matter may be added to the plating bath during makeup and/or replenishment as an auxiliary material or dispersion.

Although the present invention may include components for stability, brightness, fume control, pit reduction, or other alterations to the properties of the coatings, in some situations, platers may add additional auxiliary solutions to the plating bath for modified stability, brightness, fume control, pit reduction, or other alterations to the properties of the coatings resulting from the plating baths.

The present invention includes embodiments directed to similar practices and solutions used for electroless nickel phosphorous, nickel boron, nickel boron phosphorous, nickel tungsten phosphorous, cobalt boron, cobalt phosphorous, copper phosphorous, and other types of plating baths.

Typically the plater (the end user of the plating bath) buys the solutions needed to make up and replenish the plating baths from a supplier (a manufacturer or distributor) of such solutions.

Another important advantage of the present invention over all prior art in the field is the improved compatibility of the single solution being used for replenishment of the plating bath relative to an on-going bath compared to the historic use of two or more components for replenishment.

The first advantage in this regard is that the single solution of the present invention has a pH more compatible with the plating bath. A typical electroless nickel plating bath has an operating pH that is normally between 4.0 and 6.5. Typical C solutions have a pH between about 9.0 to 11.0. When such solutions are added to a plating bath, there is an inherent acid-base reaction. That acid base reaction can cause a precipitation of materials such as nickel hydroxide or other precipitates in the plating bath. This precipitation also includes degeneration of at least some or all of the bath components in advance of subsequent plating. This phenomenon is amplified by the fact that when the higher alkaline pH C component is added to the acidic plating bath, there can be a sharp increase in the temperature of the plating bath at the area where the replenishment is made.

Another distinction between the present invention and the historic multiple component systems is that typical A solutions with only or mainly just a nickel salt have a pH between about 3.0 to 3.5. This is lower than the typical electroless nickel plating bath where the pH is normally between 4.0 and 6.5. While another material can be added to an A component or other metal salt solution to bring the pH to say 4.0-6.5, this is not done for fear of causing the nickel to precipitate and become unstable in storage or transport. In addition, the metal salt, such as nickel sulfate, is not complexed in such a solution that is typically just a dilution of the nickel salt in water, normally deionized water. In the present invention, the metal salt is in solution with two or more complexing agents, and therefore in a nickel ligand with greater stability. This makes the solution of the present invention more compatible with the plating bath and less likely to cause precipitation, excess plating, or other negative reactions when the replenishment is added to the plating bath.

The importance of compatibility between the plating bath and any solutions or materials added to the plating bath is amplified by the elevated temperature of the plating bath. At such temperatures, the volatile reaction of common C components containing alkaline materials such as ammonia and other hydroxides or carbonates and the like are problematic to the worker who is tasked with making such replenishments to the plating bath. As the task is not pleasant from an odor, safety, and other reasons, having a single solution as in the present invention with a pH compatible with the plating bath is desirable.

For the reasons disclosed herein, the compatibility of the pH of the solution of the present invention to the plating bath of the present invention is advantageous and novel in the industry. It is desirable that the pH of the solution be similar to that of the plating bath during operation, such as but not limited to within 3 pH of one another. It is desirable that the pH of the solution be acidic if the plating bath is acidic. It is desirable that the pH of the solution is not more than three pH units different than the plating bath. Also, during operation of the bath, certain characteristics of the bath might be regularly measured, such as but not limited to temperature, pH, and metal content or density.

There exists, therefore, an unmet need for a novel electroless plating bath formulation and system of makeup and replenishment.

The present invention meets this need with a novel single solution that is useful for both plating bath makeup as well as replenishment.

As will become evident in the examples below, the present invention includes multiple combinations of ingredients in various ranges of quantities/percentages in a single solution useful to both makeup and maintain the composition of ingredients in the plating bath. In general, the present invention is comprised of a family of solutions each of which affords an improved ease of use with less room for error and may also extends the life of typical plating baths.

The present invention solves the aforementioned deficiencies and other deficiencies in conventional electroless plating bath systems by overcoming a number of factors which have limited manufacturers and users of plating baths to use plating bath systems with multiple solutions instead of a single solution. These factors include, but are not limited to, the following:

1. Keeping the metal salt(s) and reducing agent(s) in separate solutions to avoid any possible reaction between these ingredients before they are introduced to the plating bath.

2. Keeping all ingredients stable and free from precipitation while in solution. If a material precipitates out of a solution, the material will not be properly added to the plating bath and therefore cause performance problems at least at certain pH levels. Pre-present invention replenishment solutions (like a typical C solution) generally have a pH that is higher than the pH of a solution containing metal salts in high concentrations such as a typical A solution or the single solution of the present invention.

3. The usage ratios of ingredients are ordinarily different in makeup and replenishment. When making an electroless plating bath, certain ingredients are included in specified quantities, which is required for the bath to work properly. As parts are plated in the bath using the makeup solution of the present invention, each of the bath ingredients is consumed at a different rate. Some ingredients are consumed faster, some slower, and some essentially not at all. It is for this reason that the C solution typically has different concentrations of ingredients than the corresponding B solution used to make up the plating bath. In addition, it is possible to have some ingredients in a C solution that are not in the corresponding B solution that can improve the performance of the plating bath as it is used.

4. Proper stabilizer content is critical for the performance of a plating bath. Achieving this content is especially challenging as these stabilizer ingredients (such as those listed in this disclosure and others) are used in very small amounts relative to the other ingredients. Stabilizers are typically used in parts per million whereas other ingredients are used in grams per liter.

5. If any or all ingredients are not added and maintained in the proper concentrations in the plating bath, the resulting deficiencies can range from instability, overstability, precipitation, shortened bath life, and plating defects (including pits, nodules, edge problems, skip plating, streaks, inconsistent finish, deficient performance, and others).

A key measure of the quality and suitability of solutions for making up and replenishing electroless plating baths is the resulting plating rate and lifetime of the plating bath.

The plating rate corresponds to the thickness of the coating achieved from a plating bath over a period of time. For example, microns of thickness per hour is a typical measure of plating rate. There are generally accepted ranges of plating rates for various types of plating baths and these rates might differ based on the quantity and/or types of articles being plated. For example, a typical low to medium phosphorous plating bath typically plates at a rate of 15 to 25 microns per hour. A typical high phosphorous electroless nickel plating bath plates at a rate of 7 to 12 microns per hour. The plating rate of a given plating bath depends upon operating temperature, bath loading, pH, agitation, age of the bath, and other factors. The choice of type of phosphorous also depends on a variety of factors, including particularly the articles being plated and the purpose of the plating.

The present invention has novel advantages over the prior art at least in the utility of the solutions of the present invention to makeup and maintain via replenishment plating baths in a range of metal concentrations. Commercial acceptance of electroless nickel plating baths at less than the traditional concentration of 6 grams per liter of nickel metal in the plating bath has been very limited despite the background rationale noted herein. A limited number of manufacturers of plating solutions have offered plating solutions such as electroless nickel solutions that can operate a plating bath less than the traditional 6 grams per liter, for example around 3 grams per liter. Such plating systems, however, require three or more solutions which are specifically formulated to provide the plating bath at a low metal concentration. The present invention has the novel utility of providing single solutions that are able to be used to form and maintain plating baths at a range of metal concentrations including at 3 grams/liter. For example, one single solution of the present invention is able to be used to form and maintain a plating bath at 3 or 5 g/l, in between, or more or less grams per liter of metal salt in the plating bath simply by using more or less of the single solution. The present invention solves this previously unmet need and does so in a commercially acceptable and usable level.

Until the present invention, the one widespread exception to electroless nickel plating baths operating at less than 6 grams per liter of nickel metal has been the commercial acceptance of the One-Plate® product line of Surface Technology, Inc. related to U.S. Pat. Nos. 10,006,126; 10,731,257; and 10,731,258. This product line of electroless nickel plating solutions has been commercially accepted and used to typically form and replenish plating baths with a concentration of 5 grams per liter. It should be noted that these One-Plate® based plating baths also typically operate at a lower concentration of the reducing agent and thereby provide cost savings and environmental benefits similar to those associated with using a lower metal salt concentration as disclosed herein. Commercial plating bath operators have generally not accepted the concept or practice of using electroless nickel plating baths at less than the 5 to 6 grams per liter of nickel metal concentration because of operational issues.

The primary reason for this lack of commercial acceptance is that at a nickel metal concentration as low as 3 grams per liter in the plating bath, much more frequent replenishment of the plating bath is required to maintain the concentration of the metal salt and other chemical components to avoid their concentration from going even further below the already low concentration as these components are consumed in the plating reaction required to produce the electroless nickel deposit onto articles immersed into the plating bath. Such frequent replenishment requires a higher level of attention and labor time, which is required to maintain the plating bath at an acceptable level. It is analogous to an automobile with a smaller gas tank or smaller battery. There are cost, weight, and environmental benefits to having a smaller gas tank or battery but doing so would put pressure on the operator to fill the tank or charge the battery with more frequency. This increased frequency impose costs and risks of running the gas or battery charge levels too low.

The present invention overcomes these problems associated with a low metal salt concentration in a plating bath to enable the various benefits of such a system. The present invention does so as disclosed in the examples below. These examples relate to the use of an electroless nickel plating bath with a low concentration of the metal salt and reducing agent, including but not limited to when adding for the composite plating of PTFE.

Composite plating with PTFE requires the addition of a dispersion product to the plating bath. The dispersion product is typically an aqueous based mixture of PTFE particles and one or more surfactants. Typically, PTFE is added for reasons such as but not limited to a lowered coefficient of friction of the plating. It is well known in the field that adding such PTFE dispersions to the plating bath inherently reduces the plating rate of the plating bath. The plating rate reduction can be by as much as 70%. Given this reduced plating rate, we have demonstrated that with the present invention the plating bath can be reasonably maintained at commercial level standards, and thereby provide all the benefits associated with the low concentration of the metal salt, reducing agent, and other chemical ingredients. In at least some cases, the PTFE and electroless nickel combine in the deposit or coating to form a nickel-PTFE composite which becomes the deposition (or a nickel-PTFE composite becomes a part of the deposition).

A bath life is typically measured in “metal turn-overs”, or MTOs. Different baths can have different MTO lifetimes depending on a number of factors such as but not limited to the type of plating bath, the operation and maintenance of the plating bath, the quantity and types of articles plated, the base metal of the articles being plated, and other factors. One MTO represents the use of a plating bath over a period of time where parts are plated, the cumulative quantity of the metal salt in the bath at makeup is used (deposited onto parts immersed in the plating bath) and replenished into the plating bath. For example, if a one-liter electroless nickel plating bath is made up with 6 grams of nickel metal (coming from a metal salt like nickel sulfate), parts are plated therein until 0.6 grams of nickel are depleted, the bath is replenished with 0.6 grams of nickel, and this process is repeated 9 more times for a total depletion and replenishment of 6 grams of nickel, then this bath has achieved one MTO. Of course, it is not only the nickel salt that is consumed and replenished in the course of usage. Any and all reducing agent(s), stabilizer(s), brightener(s), and all other ingredients must be maintained in proper concentration in the plating bath, otherwise plating bath performance, life, and resulting plating quality will suffer. Adding too much or too little of certain ingredients can also reduce the bath life. Another factor influencing the bath life is the gradual buildup of byproducts in the plating bath as a result of the plating reaction. A maximum bath life is important to the plater since the solutions used for plating baths are a significant cost to the plater; it is time consuming, inconvenient, and costly for the plater to dispose of a used bath and replace it with a new bath; treatment of a used bath is costly and can have environmental implications. Therefore it is important to the plater that the solutions used for bath makeup and replenishment are formulated in a way as to maximize bath life and performance.

When evaluating solutions for the makeup and replenishment of an electroless plating bath, achieving at least one MTO with proper performance and results is a significant threshold to validate the composition(s) of the solution(s). Although some plating bath systems exist for the perpetual use of the plating bath, accomplished by removal of byproducts from the bath and replenishment with select materials, such baths are generally not considered practical nor economical for widespread commercial use, and therefore the life of an electroless plating bath in terms of the number of MTOs achievable is an important factor in the utility of an electroless plating bath.

Plating baths utilizing solutions of the present invention have been operated with a commercially viable plating rate, stability, and plating quality to over 12 metal turnovers. Even at 12 metal turnovers, the stability and plating quality continue to meet commercially acceptable requirements. This was not achieved for the single solution from 1975 discussed earlier.

As plating baths are used to plate articles and the baths increase in the number of metal turnovers, ultimately the bath reaches a point where, because of byproduct accumulation, the bath must be disposed of. This disposal is typically further due to the buildup of contaminants in the plating bath. These contaminants can include byproducts of the plating reaction such as sodium orthoposphite in the case of electroless nickel, other material build-up such as a zincate solution introduced to the plating bath from the pretreatment of aluminum articles prior to plating, or other contaminants from the chemical process such as the drag-in from articles immersed into the plating bath, and even material in the plating shop that can otherwise migrate into the plating bath.

As such materials build-up in the plating bath, they can cause deleterious effects including a reduced plating rate and/or quality problems with the plated deposit such as poor adhesion, pitting, roughness, lack of uniformity and other defects.

Therefore, plating baths are normally disposed of at a certain number of metal turnovers before the plating becomes poor. One reason for this commercial practice is that metal turnovers are easier to measure than the cumulative amount of known or unknown contamination. Moreover, it is general practice in the plating industry to try and dispose of a plating bath just before costly quality problems occur on the articles being plated. For example, if a plating shop anticipates adhesion problems on the plating on aluminum articles from a plating at around four metal turnovers due to the buildup contamination of zinc in the plating bath from the pretreatment process of plating on aluminum, the plating shop may discard a plating bath at three metal turnovers to avoid such potential problems and then makeup a new plating bath.

There is a method, known as “bleed and feed” that is rarely if ever practiced in advance of the present invention and not practiced commercially. In this method, as a plating bath reaches a certain number of metal turnovers, a portion of the bath is removed, that portion is replaced with a newly formed plating bath and mixed into the unremoved portion of the bath. This method effectively dilutes the plating bath with new plating bath and thereby reduces the amount of contaminants in the plating bath so the plating bath can continue to be used to plate articles with consistent performance and plating results. For example, if a plating bath were made up and used to a total of four metal turnovers and then half the plating bath were removed and replaced with a newly made up plating bath, the resulting plating bath would effectively be at two metal turnovers in terms of bath age and the amount of contamination. The benefits of such a method are that a plating bath can be used at a more steady state in terms of parameters (such as plating rate, stability, temperature, pH, etc.) and plating quality (such as adhesion, corrosion resistance, stress, color, quality, etc.)

Despite these benefits, the bleed and feed method is rarely if ever practiced commercially. There are a number of reasons for this lack of commercial acceptance. These include the additional cost of materials as traditionally the cost to makeup new bath with multiple components is greater than the cost to replenish an existing bath. There is the added time and labor cost to perform the bleed and feed process, especially with multiple components needed to make up the new portion of the bath. In addition, the bleed and feed process may result in more waste for disposal.

It is an object of the present invention to make the bleed and feed method commercially viable and advantageous. As an example below demonstrates, the novel utility of a single solution for both the makeup and replenishment of a plating bath solves this problem. As a single solution for both the makeup and replenishment of a plating bath, the present invention enables a plating shop to perform the bleed and feed method using fewer chemicals, or less of various chemicals, that is cheaper, easier, faster than it would be with a multiple solution system. The plating shop is able to bleed a portion of the plating bath and either 1) replace this portion with the same volume of a newly made-up plating bath or 2) replace this portion with just the required amount of the single solution of a present invention and dilute the plating bath up to the operating volume. This second option, facilitated by the present invention is essentially just a large replenishment to the plating bath which is made practical by the use of a single solution of the present invention for its simplicity and compatibility with the plating bath for the reasons explained in this disclosure.

When evaluating solutions for the make-up and replenishment of an electroless plating bath, verification of the physical properties of the coatings resulting from this plating bath is significant to validate the composition(s) of the solution(s). Such physical properties of the coatings include, but are not limited to, composition, hardness, corrosion resistance, thickness, uniformity, electrical conductivity and resistivity, porosity, appearance, brightness, reflectivity, adhesion, stress, elasticity, tensile strength, elongation, density, coefficient of thermal expansion, wear resistance, coefficient of friction, and/or other properties.

Additional ingredients typical in electroless plating and useful in the present invention include, but are not limited to:
Acetic Acid
Ammonium Bicarbonate
Ammonium Carbonate
Ammonium Hydroxide, Reagent
Ammonium Hydroxide, Technical
Borax
Boric Acid
Caustic Potash
Caustic Soda
Caustic Soda Beads
Citric Acid
DMAB
Glycerine
Glycine
Hydroxyacetic Acid
Lactic Acid
Malic Acid
Nickel Sulfate Liquid
Nickel Sulfate Crystal
Propionic Acid
Sodium Glucoheptonate
Sodium Hypophosphite
Sodium Isothionate
Succinic Acid
Sulfamic Acid
Sulfuric Acid, Reagent
Tartaric Acid, NF Granular

Complexers are an important factor in electroless plating solutions, plating baths and processes. One example of the relevance of complexing agents can be found in U.S. Pat. No. 5,609,767 (“Eisenmann”) even though Eisenmann is a rejuvenation type of plating bath which is different than the replenishment type of plating bath for the present invention.

Eisenmann demonstrates the importance of complexing agents in the stability and commercial viability of electroless nickel plating baths. He is very specific about his solution and that it requires, without exception, acetate or acetic acid serving as his complexer. Complexing is a term of art in the industry in which the metal portion of a metal salt becomes treated in a bath to improve the metal's ability to prevent the homogeneous reduction of the metal ions in the general bath volume (known as precipitation or decomposition) instead of heterogeneously on the article's surface where its reduction will yield a metal alloy on the surface of the article. In commercial applications, this complexing is necessary to assure proper operation of the plating bath and good, consistently uniform coverage of the resulting coating on the article being plated.

To facilitate such stable and effective operation of the plating bath, a chemical, referred to as a complexer, is added to the bath solution for complexing the metal ions in the bath, such as nickel.

Once nickel is properly complexed for a commercial plating bath, it is very difficult or impossible to subsequently separate the nickel from a bath. Consequently, in order to separate nickel, as is a goal in Eisenmann's regenerative solution, the bath either cannot have a complexer or any complexer that is used must be weak in order to separate it from the bath by ion exchange as in the complex and expensive Eisenmann process. This is why he specifically requires acetate and/or acetic acid, each of which is actually a very weak complexer. The present invention does not use such a weak complexer without at least some other complexing element.

In the present invention, there is no need to separate out nickel from the at least partially spent bath, as there is no bath regeneration process for reclaiming nickel. Further, in the present invention, there is demand to strongly complex all of the nickel so as to use nickel to its fullest advantage and for the bath to remain stable for a long life, to achieve acceptable plating rate, and for uniform and acceptable coating quality. By strongly complexing the nickel, it becomes impossible to regenerate the bath. The present invention—a single solution for a replenishable and non-regenerative bath, cannot use acetate and/or acetic acid as its sole complexer and the bath cannot be regenerated.

Eisenmann also points out that he cannot use ammonia because he needs to precipitate substances from his bath.

The present invention must have a non-acetate/acetic acid complexer which is a significantly stronger complexer than the acetate ligind as shown by its pK.

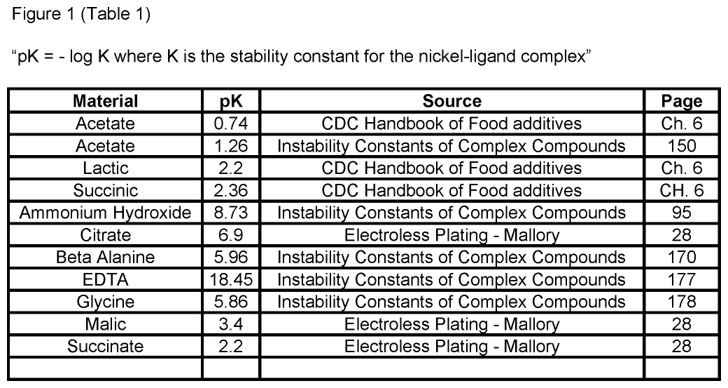

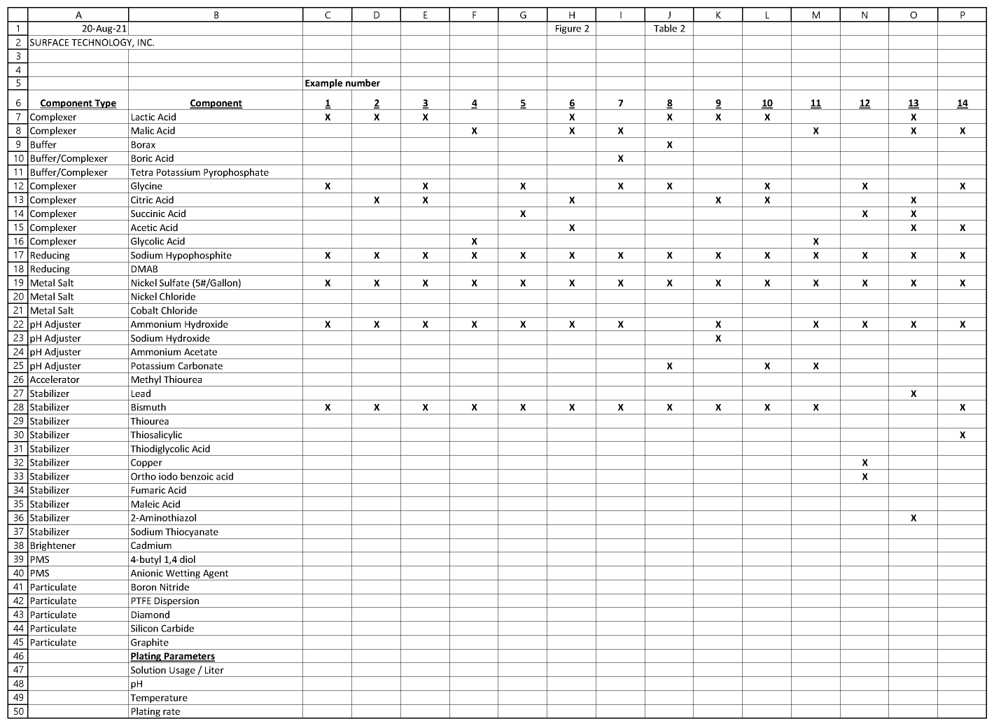

See FIG. 1, Table 1, showing stability constants (pK), on a log scale, of known complexers. A definition and additional information on pK stability can be found in Advanced Inorganic Chemistry by Cotton and Wilkinson, second edition, Chapter 5, Section 8, page 150.

Table 1 includes published data (including the sources) regarding the relative strength of many complexers potentially usable in the present invention. As is evident in Table 1, the nickel complex used by Eisenmann would have a maximum of 1.26.

The present invention includes two or more complexers and at least one pH adjuster. Eisenmann does not even suggest the need for both because he has no need for both when using acetate/acetic acid and if he had any other complexer or pH adjuster that would complex the nickel, it would be counterproductive to his solution that is directed towards regeneration.

Another key distinction to the present invention is that the metal salt is in a pre-formed solution with a reducing agent and other materials. The proper selection of these other materials, including the complexers, is important to the stability of solution in manufacture, storage, and transportation before the solution is even used for its intended plating purpose. Stability in storage and transportation requires the ability to withstand both hot and cold temperatures in order to avoid freezing, precipitation, or other reactions in the solutions. Recognizing the criticality of such stability for commercial purposes, practicality, and safety, a series of experiments disclosed herein were conducted to demonstrate the novel stability of solutions of the present invention that contain a metal salt, a reducing agent and other materials associated with the present invention.

Another key distinction of the present invention's specification of complexers is that each complexing agent is more or less effective at different pH levels. As it relates to the present invention, there are four relative pH levels where complexing and the resulting stability and performance are required. 1) the pH level of a concentrate of the present invention, 2) the pH level of a solution of the present invention that may be formed from a concentrate or from individual ingredients, 3) the pH level of a plating bath as formed, and 4) the pH level of the plating bath during use to plate articles when the pH will change as a result of the plating reaction.

While not wanting to be bound by theory, the utility of including two or more complexers in the present invention is novel and significant for proper complexing of the nickel in a solution of the present invention because each complexer can be different in size from other complexers. This is related to the size of the acid group of each complexer. From a geometric perspective at the molecular level, therefore, it is useful to have complexers of different sizes. The acid or bonding group of one complexer may be so large that when it bonds to one site of the nickel ion the complexer may be position such that it will block adjacent sites on the nickel ion that would therefore go uncomplexed, or simply hydrated. Having a second smaller complexer would allow for that second complexer to bond to those otherwise vacant sites on the nickel. This combination of two complexers provides for increased stability and a stronger total complexing of the nickel and a higher pK value of the complexed nickel (so called “nickel complex” or “nickel ligand complex”) while in solution. As noted herein, before the family of the present invention, the metal salt and the complexer were typically separated for storage and transit and only came together at the time of bath formulation so as to prevent the nickel from complexing too soon. In the present invention, the nickel somewhat complexes in the pre-mixed solution, and does so in a stable way, so that the ingredients can be pre-mixed and packaged together. This partial complexing at least in part, provides the stability in the packaged form, with further complexing in the bath. It is believed that complexing nickel while in solution for later plating may alone be novel and provides some or all of the benefits later discussed. It is believed that one point of novelty of the present invention is the use of a plurality of complexers used for a plating solution, and used in a single makeup/replenishment solution. In one example, the nickel complex in solution has a pK value at or exceeding 1.5. In other examples, the nickel complex in solution has a pK value exceeding 3 or exceeding 4. In one additional example, the nickel further complexes while in the bath, such as possibly due to one or more of temperature, pH change, agitation, or other reasons, hence the benefit of a plurality of complexers.

The utility of two or more complexers in the present invention is therefore to provide the desired level of complexing and stability across the multitude of situations in which they are employed in the present invention including but not limited to manufacture, combination with other materials, storage, transport, temperature level, pH level, plating, and relevant commercial and regulatory requirements.

The importance of the complexers and other materials is of further relevance in solutions formulated without lead, cadmium, thiourea, and other ingredients that may be avoided despite their stability and/or efficacy due to environmental and regulatory purposes such as RoHS and the like. Therefore the importance of an adequate pk value is even more important to maintain stability in the plating bath as well as in the plating solution where the metal salt and reducing agent are pre-combined and must remain stable.

Another example of the utility of the present invention is to solve the need for enhanced stability of a solution, especially for manufacture, storage and transportation, in that the present invention can be formulated as a concentrate which can be later combined with other ingredients like a metal salt and/or reducing agent to form a solution of the present invention. In addition, such a concentrate of the present invention can be used to both makeup and replenish the same plating bath along with one or more materials such as a metal salt and/or a reducing agent. In addition to stability, such a concentrate provides commercial advantages such as reduced transportation costs and the potential for lower costs to the manufacturer, distributor, and/or end user plater.

Once the bath has been prepared, it is ready for use in the electroless plating process of the present invention. This involves contacting the surface of an article to be plated or coated with the electroless metallizing bath. However, the article to be coated may require preliminary preparation prior to this contact in order to enable the autocatalytic plating deposition on the surface of the article. This preparation includes the removal of surface contaminants. For example, this process may involve any of, but not limited to, degreasing, alkaline cleaning, electrocleaning, zincating, water or solvent rinsing, acid activation, pickling, ultrasonic cleaning, physical modification of the surface, vapor or spray treatments, etc.

An electroless plating bath is typically operated generally according to the following practices related to the equipment, and operation of the bath.
The plating tank is typically constructed of polypropylene, stainless steel (Type 316) or mild steel with a suitable tank liner depending on bath in use and other considerations. Stainless steel tanks may be anodically protected.
Filtration through a 10-micron or finer rated polypropylene filter bag system is suggested. Polypropylene wound cartridge filters are also permissible, but are not as easy to use as filter bags. The filtering pump system should turn the bath over at a rate of at least 10 times per hour.
Agitation is useful in maintaining bath homogeneity and for providing a consistent finish for the coating. Air spargers with air from a high volume, low-pressure air blower is recommended. Compressed air is not recommended due to potential oil contamination. Other types of agitation, may also be used.
Heating of the bath may be accomplished by various methods including heat exchangers and immersion heaters. The bath temperature should be monitored and maintained closely.
Cooling of the bath with an appropriate cooling apparatus should be done rapidly at the end of a shift or any time the bath will not be used for an extended period of time.
Rack, barrel, and fixturing devices are typically constructed of compatible materials such as polypropylene, chlorinated polyvinyl chloride (CPVC), stainless steel, PTFE, Viton, silicone rubber, and others that can withstand the chemicals and temperature of the plating bath and pretreatment process. Maskants may be used to protect fixtures from being plated.
Masking is typically accomplished with compatible materials such as certain vinyl tapes, stop-off paints, plugs and gaskets made of Viton, silicone rubber, and others that can withstand the chemicals and temperature of the plating bath and pretreatment process.
The plating tank should be clean and passivated. The most common method is with a solution of 40-50% nitric acid for 2-3 hours at room temperature, followed by rigorous rinsing and neutralizing of the tank and verification that no nitrate contamination remains.
The plating bath is typically maintained to be within 80% and 100% concentration of nickel, hypophosphite, stabilizers, or other chemicals based on the initial makeup concentration of these ingredients. Tighter control further helps performance.
Titration of the plating bath is typically before and after every batch of parts that is plated. Replenishing is normally done during plating cycles if the workload will lower the nickel concentration to 90% or less.
Continual and accurate measurement of bath temperature, pH, and bath solution level is important and typically done. Evaporation will reduce bath volume and give false indication of actual concentration. Adding DI water as needed during the plating cycle is useful to keep solution at proper level.
The deposition rate of a given plating bath depends upon operating temperature, bath loading, pH, agitation, age of the bath, and other factors.

The technique of blackening electroless nickel coatings is known in the industry. A number of methods have been developed to produce black electroless nickel. The most common process is generally characterized by the oxidation or etching of an electroless nickel coating. Oxidizing materials that can be used include acids, metal chlorides, peroxides and other oxidizing agents.

Another method involves adding materials to the electroless nickel plating bath similar to what can be used in black electrolytic nickel plating baths. Such ingredients may include zinc and/or sulfur. Such materials may be included in the solutions of the present invention.

These and other objects of the present invention together with the advantages over the existing prior art and method will become apparent from the following specification and the method described herein.

The preferred embodiments of the present invention are detailed in the examples.

The more recent use of stabilizers other than lead in electroless nickel plating baths has enabled the utility of the present invention. Lead, the traditional stabilizer in electroless nickel systems, works in the plating bath in a very tight range of about 1 to 3 parts per million. Too little lead and the bath will produce plating defects, become over active, and/or decompose. Too much lead and the bath will produce plating defects, plate too slowly, and/or stop plating. Keeping the lead stabilizer within the tight range required for proper bath operation, proper plating quality, and proper bath life is one of the reasons why a single solution useful for the makeup and replenishment of an electroless plating bath was not possible until the present invention. In a preferred embodiment of the present invention, the single solution useful for the makeup and replenishment of an electroless plating bath uses materials other than lead, and these other materials are able to stabilize the plating bath within a much broader range than the traditional lead stabilizers. Such non-lead stabilizers include, but are not limited to bismuth, copper, antimony, and non-metal stabilizers either individually or in combination. For example, lead is generally effective in a range of only about 1 to 3 parts per million in an electroless nickel plating bath, whereas bismuth is effective in a range of about 1 to 50 parts per million in an electroless nickel plating bath. These non-lead stabilizers provide other benefits as well.

It is important to note that just as lead is a highly effective stabilizer for electroless nickel plating baths, lead is also highly effective to stabilize a plating solution of the present invention where the metal salt and reducing agent are combined in a single solution useful for forming and subsequently replenishing a plating bath. Therefore, the avoidance of lead in such solutions for health, regulatory, environmental or other reasons poses challenges to formulating a stable solution that will also perform properly under commercial conditions including manufacture, transportation, storage and use of the solution which can be in containers of any size including buckets, carboys, drums, totes and tanker trucks. Instability of a plating solution in a container can result in a plating reaction occurring within the container which could cause the generation of gas within the container. If the container is closed, bloating or damage to the container can occur. Such bloating or damage can be dangerous and can cause environmental problems if the contents were to leak. Such a reaction within the container could also render the solution unusable for plating. The ability of the present invention to make such solutions without lead, cadmium, and/or other ingredients while providing such stability of the solution in a container at a range of temperatures demonstrates the accomplishment and utility of the present invention.

Similarly, thiourea has been widely accepted and used as a traditional sulfur-based compound stabilizer in electroless nickel plating baths. Sulfur functions in an electroless nickel system mainly as a stabilizer, and the ratio of sulfur to the lead or other metal stabilizer in the plating bath can affect the performance of the plating bath and the properties of the plating itself. And similar to lead, thiourea works in the plating bath in a very tight range. Too little thiourea and the bath will produce plating defects and/or decompose. Too much thiourea and the bath will produce plating defects and/or stop plating. In a preferred embodiment of the present invention, the single solution useful for the makeup and replenishment of an electroless plating bath can use materials other than thiourea, and these other materials are able to function in the plating bath within a much broader range than the traditional thiourea. Such non-thiourea sulfur compounds include, but are not limited to thiosalicylic acid, thiodipropionic acid, and the like. For example, thiourea is generally effective in the range of only about 1 to 5 parts per million in an electroless nickel plating bath, whereas thiosalicylic acid is effective in the range of about 1 to 30 parts per million in an electroless nickel plating bath, and thiodipropionic acid is effective in the range of about 1 to 300 parts per million in an electroless nickel plating bath.

Although the examples detailed below depict specific combinations of components, time, and control, the reader should recognize that the present invention is not limited to the specific materials and metrics in the examples. For example, plating different goods may require different quantities or combinations. The pH of the plating bath can vary by application but is preferably in a range of 4.0 to 9.0. The plating bath temperatures can preferably be in the range of 20 to 100 degrees Celsius. The duration of the cycle times can be in any range required to provide the coating thickness and properties desired.

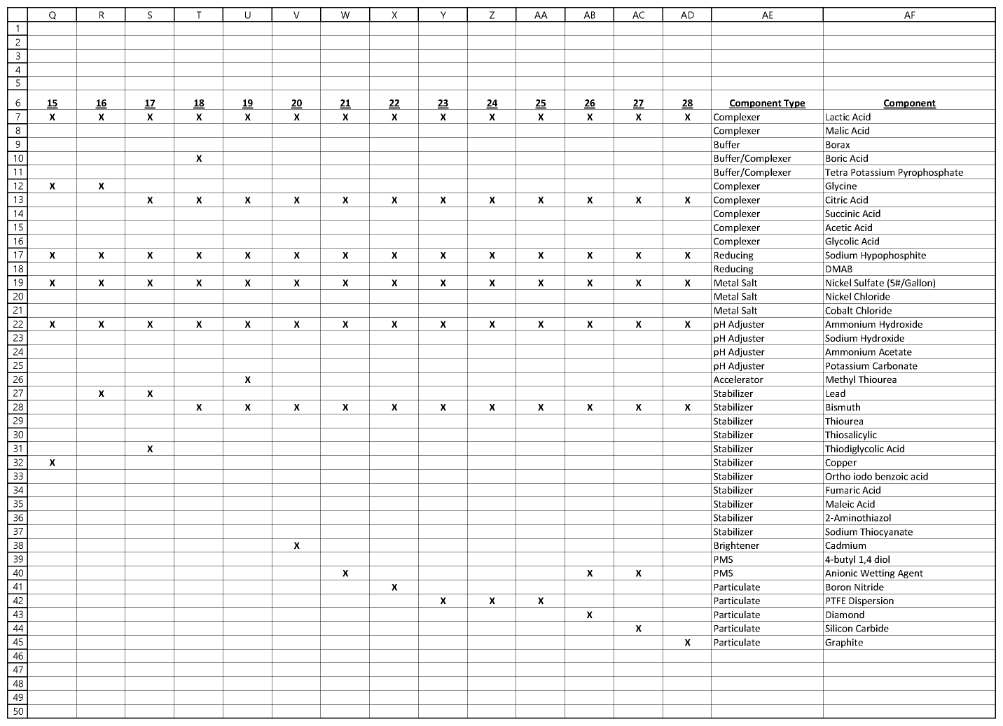

The single solution of the present invention can take any of several forms, such as but not limited to the forms described in Table 2 (in FIG. 2). In general, these solutions include one or more metal salts, complexers, reducing agents, pH adjusters, and stabilizers, and may also contain one or more forms of particulate matter and particulate matter stabilizers. In a preferred embodiment, the single solution, pre-mixed, is used for formulating a bath further comprising water, where the bath is carefully controlled with respect to pH and temperature, and the plating rate is also carefully controlled. In this embodiment the same single solution is used for replenishment.

In a preferred embodiment of the present invention, nickel sulfate metal salt and sodium hypophosphite reducing agent are in the solution in respective concentrations to provide for a ratio of nickel metal to hypophosphite of about 0.2 to 1.0 by volume in the plating bath.

The solution of the present invention's contents may vary based on the plating needs, such as but not limited to, the type of plating necessary, and the types of objects being plated. Preferably, the solution is directed to electroless nickel plating, but other types of plating may also lend themselves to a single solution, such as but not limited to other types of electroless nickel plating.

Again, the initial solution and the replenishment solution of the present invention are exactly the same. In general, during plating, the individual contents of the single solution will deplete from the bath, and the introduction of replenishment solution may change the overall mix in some ways (consequential to variation in the depletion rates of the various component elements), but the overall ability to plate and for the bath to remain usable through at least 12 MTOs will not be impacted by the introduction of replenishment solution.

### Example 1

A solution as listed in each of the columns C through AD in Table 2 (in FIG. 2) was prepared with quantities recorded of the ingredients as in rows 7 through 45 of Table 2 (in FIG. 2). by dissolving the prepared solution in water. Each of these examples describes a solution usable as both the initial solution where water is added and is also usable identically as the replenishment solution, typically without the need to add additional water. Of course, different of these examples might be applicable to different plating situations, however, each has been shown to be usable in the single solution composition described in this application. In the solutions listed in each of the columns X through AD, insoluble particulate matter was also added as listed in rows 41 through 45.

Each of the above solutions was stored at room temperature of 20 degrees Celsius for 15 days and inspected for precipitation or other degradation. The same solutions were then stored in a −5 degree Celsius environment for 30 days, removed from this environment and inspected for precipitation or other degradation, then stored in a 40-45 degree Celsius environment for 30 days, removed from this environment, and inspected to for precipitation or other degradation. It was determined that there was no precipitation or degradation in each inspection.

A quantity of each of the above solutions was diluted to one liter with deionized water to form an electroless plating bath. The quantity of the solution that was diluted to a one liter plating bath was at various quantities ranging from 100 milliliters to 200 milliliters. Mild agitation was introduced to each plating bath. The pH of each of the baths had a pH value maintained between 4.5 and 6.5, measured as formed by the respective solution after just dilution with water, or after adjustment with an auxiliary solution and at other times during plating. Each plating bath was heated to the operating temperature at a variety of temperatures between 74 and 95 degrees Celsius.

Substrates made of steel, stainless steel, copper and/or aluminum alloys were cleaned and otherwise pretreated and immersed into the plating baths formed by the solutions listed in Table 2 (in FIG. 2). The substrates were left in the plating baths for cycle times from 15 to 240 minutes, during which time the pH, temperature and agitation of the plating baths were monitored and maintained. The substrates were removed and both the substrates and plating baths were analyzed.

Each of the plating baths were analyzed by titration for the metal salt concentration and replenished with the required quantity of the exact same solution used in the makeup of the respective plating bath to return metal salt concentration of the plating bath to the same starting concentration as its initial makeup. The solution as used for replenishment was the exact same as used for makeup of the plating bath in each example as on Table 2 (in FIG. 2). The replenishment of the plating bath was made during and/or after the substrates were being plated in the plating bath.

This process of plating substrates, analyzing the substrates, analyzing the baths, and replenishing the baths was continued until the baths reached at least one metal turnover. This process was implemented at timing consistent with conventional plating practice in order to maintain the concentration of materials in the plating bath in a useful range. Throughout the process, the pH, temperature and agitation were maintained, and the plating reaction was observed by the bubbles evolving from the substrates. This process was performed on each of the plating baths formed from the solutions listed in Table 2 (in FIG. 2) over the course of a number of days with the baths cooled at the end of use on one day and reheated to the operating temperature on the following day. This process is representative of the typical usage of a plating bath in a commercial practice.

The electroless platings produced by each of the plating baths made from each of the plating baths formed from the solutions listed in Table 2 (in FIG. 2) were analyzed. In those examples, where insoluble particulate matter was included in the solution used in each of these plating baths, the resulting platings were analyzed by cross sectional examination to verify the incorporation of these particulate materials in the plating.

### Example 2

A solution consistent with the present invention was prepared.

This solution was stored at room temperature of 20 degrees Celsius for 15 days, 14 days at 60 degrees Celsius, 4 days at 70 degrees Celsius, 15 days at −15 degrees Celsius, and then inspected to confirm no precipitation, freezing, or other degradation.

Following the temperature storage validation, a first 135 milliliters of the above solution was diluted to 900 milliliters with water to form an electroless plating bath with a nickel metal concentration of 5 grams per liter and a hypophosphite concentration of 25 grams per liter in the plating bath. Mild agitation was introduced to the bath. The pH of this bath was 5.8. The bath was then heated to the operating temperature of 88 degrees Celsius.

A substrate was cleaned and otherwise pretreated and immersed in the plating bath for one hour during which an electroless nickel plating was formed on the substrate. During this plating cycle the pH, temperature, and agitation of the plating baths were maintained. During the plating cycle, the plating bath was analyzed by titration for the metal salt concentration and replenished with the required quantity of the exact same solution used in the makeup of the respective plating bath to return metal salt concentration of the plating bath to the same starting concentration as its initial makeup. The solution as used for replenishment was the exact same as used for makeup of the plating bath. The cumulative amount of the solution used for said replenishment was 30 milliliters. The depletion of 30 milliliters over the course of the one hour plating cycle relates to 0.22 metal turnovers for this plating bath and a total of 1.11 grams of nickel metal plated from this plating bath.

After the plating cycle, the substrate was removed and both the substrate and plating baths were analyzed. The thickness of the electroless nickel coating was measured to be 0.0009 inches.

This process of plating substrates, analyzing the substrates, analyzing the baths, and replenishing the baths was continued until the bath reached a total of one metal turnover. Throughout the process, the pH, temperature, concentration, and agitation were maintained. Throughout the process, the plating rates were measured and were consistent with the data noted above. This process was performed on the plating bath over the course of a number of days. This process is representative of the typical usage of a plating bath in a commercial practice.

The plating process performed over this multitude of days to achieve a cumulative one metal turnover was done in the same plating tank without the need to remove the plating bath from the plating tank in order to perform maintenance on the plating tank, such as passivation, to demonstrate the stability of the plating bath formed by and replenished with the same solution.

A second 135 milliliters of the above solution was diluted to 900 milliliters with deionized water to form a second electroless plating bath with a nickel metal concentration of 5 grams per liter and a hypophosphite concentration of 25 grams per liter in the plating bath. Mild agitation was introduced to the bath. The pH of this bath was 5.8. The bath was then heated to the operating temperature of 88 degrees Celsius.

A substrate was cleaned and otherwise pretreated and immersed in the plating bath for one hour during which an electroless nickel plating was formed on the substrate. During this plating cycle the pH, temperature, and agitation of the plating baths were maintained. During the plating cycle, the plating bath was analyzed by titration for the metal salt concentration and replenished with the required quantity of the exact same solution used in the makeup of the respective plating bath to return metal salt concentration of the plating bath to the same starting concentration as its initial makeup. The solution as used for replenishment was the exact same as used for makeup of the plating bath. The cumulative amount of the solution used for said replenishment was 30 milliliters. The depletion of 30 milliliters over the course of the one hour plating cycle relates to 0.22 metal turnovers for this plating bath and a total of 1.11 grams of nickel metal plated from this plating bath.

After the plating cycle, the substrate was removed and both the substrates and plating baths were analyzed. The thickness of the electroless nickel coating was measured to be 0.0009 inches.

This process of plating substrates, analyzing the substrates, analyzing the baths, and replenishing the baths was continued until the bath reached 12 metal turnovers. Throughout the process, the pH, temperature, concentration, and agitation were maintained. Throughout the process, the plating rates were measured. As the plating rate decreased with increased metal turnovers, as is typical of electroless nickel plating baths in commercial use, the temperature and pH of the plating bath were increased to maintain a commercially viable plating rate. At 12 metal turnovers, the plating rate of this plating bath was approximately 0.0006 inches per hour. This process was performed on the plating bath over the course of a number of days. This process is representative of the typical usage of a plating bath in a commercial practice.

90 milliliters of the above solution was diluted to 900 milliliters with deionized water to form a second electroless plating bath with a nickel metal concentration of 3.3 grams per liter and a hypophosphite concentration of 16.5 grams per liter in the plating bath. 5.4 milliliters of a dispersion containing PTFE particles made without PFOA, PFOS, and fluorinated surfactants was added to the plating bath. Mild agitation was introduced to the bath. The pH of this bath was 5.8. The bath was then heated to the operating temperature of 88 degrees Celsius.

A substrate was cleaned and otherwise pretreated and immersed in the plating bath for one hour during which an electroless nickel plating was formed on the substrate. During this plating cycle the pH, temperature, and agitation of the plating baths were maintained. During the plating cycle, the plating bath was analyzed by titration for the metal salt concentration and replenished with the required quantity of the exact same solution used in the makeup of the respective plating bath to return metal salt concentration of the plating bath to the same starting concentration as its initial makeup. The solution as used for replenishment was the exact same as used for makeup of the plating bath. The cumulative amount of the solution used for said replenishment was 13.5 milliliters. The depletion of 13.5 milliliters over the course of the one hour plating cycle relates to 0.15 metal turnovers for this plating bath and a total of 0.49 grams of nickel metal plated from this plating bath.

After the plating cycle, the substrate was removed and both the substrate and plating baths were analyzed. The thickness of the composite electroless nickel-PTFE coating was measured to be about 0.0005 inches. The coating on the substrate was analyzed by cross sectional examination which demonstrated a concentration of approximately 30% by volume of PTFE particles dispersed throughout the coating.

This process of plating substrates, analyzing the substrates, analyzing the baths, and replenishing the baths was continued until the bath reached at least 10 metal turnovers. Throughout the process, the pH, temperature, concentration, and agitation were maintained. Throughout the process, the plating rates were measured and were consistent with the data noted above. As the plating rate decreased with increased metal turnovers, as is typical of electroless nickel plating baths in commercial use, the temperature and pH of the plating baths were increased to maintain a commercially viable plating rate. This process was performed on the plating bath over the course of a number of days. This process is representative of the typical usage of a plating bath in a commercial practice.

The plating process performed over this multitude of days to achieve a cumulative one metal turnover was done in the same plating tank without the need to remove the plating bath from the plating tank in order to perform maintenance on the plating tank, such as passivation, to demonstrate the stability of the plating bath formed by and replenished with the same solution.

Therefore, the plating rate and solution depletion rate of this second plating bath of this example containing PTFE particles were all approximately 66% less than the first plating bath of this example that did not contain PTFE particles.

### Example 3

A solution consistent with a medium phosphorous electroless nickel bath of the present invention was prepared.

Separate samples of this same solution were stored at various temperatures for various durations as follows:

Sample 3-1 was stored for 30 days at room temperature of 20 degrees Celsius and then inspected to confirm no precipitation or other degradation.

Sample 3-2 was stored for 15 days at 60 degrees Celsius and then inspected to confirm no precipitation or other degradation.

Sample 3-3 was stored for 4 days at 70 degrees Celsius and then inspected to confirm no precipitation or other degradation.

Sample 3-4 was stored for 30 days at −15 degrees Celsius, and then inspected which showed no freezing of the solution.

Following the temperature storage trials above, 135 milliliters of each of the four above solution samples were diluted to 900 milliliters with deionized water to form four different electroless plating baths with a nickel metal concentration of 5 grams per liter in each of the plating baths. Mild agitation was introduced to the baths. The pH of each of these four baths was 5.8. The baths were then heated to the operating temperature of 88 degrees Celsius.

Substrates were cleaned and otherwise pretreated and one immersed in each of the four plating baths for one hour during which an electroless nickel plating was formed on the substrate. During this plating cycle the pH, temperature, and agitation of the plating baths were maintained. During the plating cycle, each of the plating baths was analyzed by titration for the metal salt concentration and replenished with the required quantity of the exact same solution used in the makeup of the respective plating bath to return metal salt concentration of the plating bath so as to the same starting concentration as its initial makeup.

After the plating cycle, the substrates were removed from each plating bath and the substrates and plating baths were analyzed.

This process of plating substrates, analyzing the substrates, analyzing the baths, and replenishing the baths with the same sample of the solution as each bath was initially made up from was continued until each bath reached 12 metal turnovers. Throughout the process, the pH, temperature, concentration, and agitation were maintained. Throughout the process, the plating rates were measured. As the plating rate decreased with increased metal turnovers, as is typical of electroless nickel plating baths in commercial use, the temperature and pH of the plating baths were increased to maintain a commercially viable plating rate. This process was performed on the plating baths over the course of a number of days. This process is representative of the typical usage of a plating bath in a commercial practice.

### Example 4

A solution consistent with a high phosphorous electroless nickel of the present invention was prepared.

Separate samples of this same solution were stored at various temperatures for various durations as follows:

Sample 4-1 was stored for 30 days at room temperature of 20 degrees Celsius and then inspected to confirm no precipitation or other degradation.

Sample 4-2 was stored for 30 days at 60 degrees Celsius and then inspected to confirm no precipitation or other degradation.

Sample 4-3 was stored for 30 days at 70 degrees Celsius and then inspected to confirm no precipitation or other degradation.

Sample 4-4 was stored for 30 days at −5 degrees Celsius, and then inspected which showed no freezing of the solution. Sample 4-4 was then stored for 7 days at −15 degrees Celsius, and then inspected which showed freezing of the solution. This frozen solution sample was allowed to thaw at room temperature for 2 days.

Following the temperature storage trials above, 135 milliliters of each of the four above solution samples were diluted to 900 milliliters with deionized water to form four different electroless plating baths, each with a nickel metal concentration of 5 grams per liter in each of the plating baths. Mild agitation was introduced to the baths. The pH of each of these four baths was 5.0. The baths were then heated to the operating temperature of 85 degrees Celsius.

Substrates were cleaned and otherwise pretreated and one was immersed in each of the four plating bath for one hour during which an electroless nickel plating was formed on the substrate. During these plating cycles the pH, temperature, and agitation of the plating baths were maintained. During the plating cycles, the plating baths were analyzed by titration for the metal salt concentration and replenished with the required quantity of the exact same solution used in the makeup of the respective plating bath to return metal salt concentration of the plating bath to the same starting concentration as its initial makeup.

After the plating cycle, the substrates were removed from each plating bath and the substrates and plating baths were analyzed.

This process of plating substrates, analyzing the substrates, analyzing the baths, and replenishing the baths with the same sample of the solution as each bath was initially made up of was continued until each bath reached 9 metal turnovers. Throughout the process, the pH, temperature, concentration, and agitation were maintained. Throughout the process, the plating rates were measured. As the plating rate decreased with increased metal turnovers as is typical of electroless nickel plating baths in commercial use, the temperature and pH of the plating baths were increased to maintain a commercially viable plating rate. This process was performed on the plating baths over the course of a number of days. This process is representative of the typical usage of a plating bath in a commercial practice.

### Example 5

A solution consistent with a medium phosphorous electroless nickel bath of the present invention was prepared.

135 milliliters of the above solution was diluted to 900 milliliters with deionized water to form an electroless nickel plating bath with a nickel metal concentration of 5 grams per liter in the plating bath. Mild agitation was introduced to the bath. The pH of the bath was 5.8. The bath was then heated to the operating temperature of 88 degrees Celsius.

An aluminum substrate was cleaned and otherwise pretreated in a process including an immersion in a zinc-containing solution and then immersed in the plating bath for 45 minutes during which an electroless nickel plating was formed on the substrate, and zinc was introduced to the plating bath. During this plating cycle the pH, temperature, and agitation of the plating bath was maintained. During the plating cycle, the plating bath was analyzed by titration for the metal salt concentration and replenished with the required quantity of the exact same solution used in the makeup of the respective plating bath to return metal salt concentration of the plating bath to the same starting concentration as its initial makeup.

After the plating cycle, each substrate was removed from the plating bath and both the substrates and plating baths were analyzed.

This process of plating aluminum substrates, analyzing the substrates, analyzing the bath, and replenishing the bath with the same solution as was initially used to form the plating bath was continued until the plating bath reached 3 metal turnovers. Throughout the process, the pH, temperature, concentration, and agitation were maintained in the same manner as the initial plating cycle was from this experiment. Throughout the process, the plating rates were measured. Throughout this process, the quality of the plating on the substrates was inspected and verified.

At 3 metal turnovers, 300 milliliters of the plating bath was removed and replaced with either a) 300 milliliters of a newly made plating bath formed by 45 milliliters of the above solution diluted to 300 milliliters with deionized water, or b) the addition of 45 milliliters of the above solution to the plating bath and then diluting the plating bath to the operating volume of 900 milliliters. This bleed and feed process effectively reduced the concentration of byproducts and contaminants from the level commensurate with 3 metal turnovers to a level commensurate with 2 metal turnovers. After each bleed and feed, aluminum substrates where sequentially plated in the same manner as described above until the plating bath again reached 3 metal turnovers.

This bleed and feed process was repeated a total of four times each time the plating bath reached 3 metal turnovers to thereby bring the plating bath to a cumulative 7 metal turnovers.

Immediately following each of the four bleed and feed processes, the concentrations of the metal salt, the reducing agent, and zinc in the plating bath was analyzed by laboratory techniques. Throughout the experiment, each time the plating bath underwent this bleed and feed process, the metal salt was within 0.15 grams per liter of the initial 5 grams per liter concentration in the plating bath, the reducing agent was within 1.7 grams per liter of the initial 25 grams per liter concentration in the plating bath, and the zinc was within a 2.7 percent of the average zinc concentration during the bleed and feed portion of the plating bath's cycle lasting from the third to seventh metal turnover.

This experiment was discontinued at the seventh cumulative metal turnover but as one skilled in the art would recognize, use of this plating bath could have been continued with the same bleed and feed procedure using the same single solution of the present invention to continue to achieve the benefits described herein on a perpetual basis.

### Example 6

An electroless nickel plating bath was formed with A and B components (Example 6-1). The bath was adjusted to an operating temperature of 88 degrees Celsius and pH of 5.0. The bath was used to plate articles until the concentration of the nickel was depleted by 15%. A replenishment with a C component at 20 degrees Celsius and having a pH of 9.2 was added slowly to the 88 degrees Celsius bath to compensate for the 15% depletion. At the surface of the plating bath, where the C component was added slowly, there was a violent in-bath reaction where the bath changed in color from a dark green to a light/medium blue, and the temperature of the bath increased from 88 to 90.5 degrees Celsius. Conventional wisdom is that when such a reaction occurs the composition of one or more of the materials in the plating bath are altered.

In contrast, a second electroless nickel plating bath was formed (Example 6-2) with a single component consistent with the present invention. The bath was adjusted to an operating temperature of 88 degrees Celsius and a pH of 5.0. The bath was used to plate articles until the concentration of the nickel was depleted by 15%. A replenishment with the same single component as used to form the plating bath at 20 degrees Celsius having a pH of 5.4 was added slowly to the 88 degrees Celsius bath to compensate for the 15% depletion. At the surface of the plating bath where the single component was added, no reaction, no color change, nor any increase in temperature occurred.

A third plating bath was formed with A and B components (Example 6-3). The bath was adjusted to an operating temperature of 88 degrees Celsius and a pH of 5.0. The bath was used to plate a smooth steel panel to a thickness of 0.001 inches. No replenishment of the bath was made during this plating cycle. After this plating cycle, the surface of the electroless nickel plating on the panel was inspected and found to be smooth and of commercial quality.

A fourth electroless nickel plating bath was formed (Example 6-4) with A and B components the same as the third plating bath. The bath was adjusted to an operating temperature of 88 degrees Celsius and a pH of 5.0, the same as the third plating bath. The bath was used to plate a smooth steel panel to a thickness of 0.001 inches. The panel in this fourth bath was the same type as that plated in the third electroless nickel plating bath. During this fourth plating cycle, replenishment with a C component at 20 degrees Celsius and having a pH of 9.2 was added slowly to the 88 degrees Celsius bath to compensate for the depletion and maintain the concentration of the plating bath near its 100% level as made up. When the C component was added, a violent reaction occurred at the surface of the plating bath, where the bath changed in color from a dark green to a light/medium blue, and the temperature of the bath increased from 88 to 90.5 degrees Celsius. Conventional wisdom is that when such a reaction occurs the composition of one or more of the materials in the plating bath are altered. After this plating cycle, the surface of the electroless nickel plating on the panel was inspected and found to have a multitude of small pits in the surface of the coating, a condition that would not be of commercial quality.

A fifth electroless nickel plating bath was formed (Example 6-5) with a single component consistent with the present invention. The bath was adjusted to an operating temperature of 88 degrees Celsius and pH of 5.0. The bath was used to plate a smooth steel panel to a thickness of 0.001 inches. No replenishment of the bath was made during this plating cycle. After this plating cycle, the surface of the electroless nickel plating on the panel was inspected and found to be smooth and of commercial quality.

A sixth electroless nickel plating bath was formed (Example 6-6) with a single component consistent with the present invention the same as the fifth electroless nickel plating bath. The bath was adjusted to an operating temperature of 88 degrees Celsius and pH of 5.0 the same as the fifth electroless nickel plating bath. The bath was used to plate a smooth steel panel to a thickness of 0.001 inches. The steel panel in the sixth plating bath was the same type as that plated in the fifth electroless nickel plating bath. During this plating cycle, replenishment with the same single component as used to form the plating bath was added slowly to the bath to compensate for the depletion and maintain the concentration of the plating bath near its 100% level as made up. At the surface of the plating bath where the single component was added, no reaction, no color change, and no increase in temperature occurred. After this plating cycle, the surface of the electroless nickel plating on the panel was inspected and found to be smooth and of commercial quality.

1-67. (canceled)

68. A packaged plating solution concentrate for a replenishable electroless nickel plating bath, comprising:
nickel sulfate;
sodium hypophosphite;
two or more complexers, wherein at least two of said two or more complexers each has a pK of at least 1.5;
a pH adjuster consisting of a compound with at least one of ammonium hydroxide, ammonium bicarbonate, ammonium carbonate, ammonium chloride, sodium hydroxide, or potassium carbonate; and
a stabilizer, where said stabilizer is absent thiourea;
wherein said plating solution concentrate is mixable with water to form said electroless nickel plating bath, wherein said bath is in a plating tank operated in a defined pH range for plating a plurality of articles with an electroless nickel deposit, the same solution concentrate is also usable in the same proportions for replenishing said electroless nickel plating bath, and the pH of said solution concentrate is within 3 of said defined pH range.

69. The plating solution concentrate of claim 68, wherein said solution concentrate is further usable to form an initial electroless nickel plating bath and to replenish said electroless nickel plating bath, each following storage for at least 14 days at at least −15 degrees Celsius.

70. The plating solution concentrate of claim 68, wherein the plating solution is free of ammonia.

71-72. (canceled)

73. The plating solution concentrate of claim 68, wherein said solution concentrate is stable as packaged for at least 4 days at 70 degrees Celsius or greater, and is usable to form an initial plating bath and to replenish said plating bath following storage for at least 4 days at 70 degrees Celsius or greater, where stability is defined as the solution concentrate will not precipitate, dissociate, or otherwise adversely react while in storage.

74. The plating solution concentrate of claim 68, wherein said solution can be thawed after freezing and remain usable to form an initial plating bath and to replenish said plating bath.

75. The plating solution concentrate of claim 68, wherein said electroless nickel plating bath can be used for plating a plurality of articles to at least 12 metal turnovers.

76. The plating solution concentrate of claim 68, wherein said electroless nickel plating bath further comprises at least one of diamond, silicon carbide, boron nitride, polytetrafluoroethylene (PTFE), graphite, carbides, oxides, and fluorides.

77. The plating solution concentrate of claim 68, wherein a said electroless nickel plating bath comprises between 3 and 5 grams per liter of nickel and said bath further comprises a dispersion containing PTFE particles and one or more surfactants for producing an electroless nickel-PTFE composite deposit.

78. The plating solution concentrate of claim 68, wherein said dispersion is free of perfluorooctanoic acid (PFOA) and/or perfluorooctane sulfonate (PFOS).

79. A plating solution concentrate for a replenishment plating process comprising, in defined concentrations:
two or more complexers;
at least one pH adjuster; and
at least one stabilizer for stabilizing a plating reaction;
wherein said plating solution concentrate is mixable with at least one of the group consisting of a nickel metal salt and a reducing agent to form a plating bath, and said plating solution concentrate in the same defined concentrations is usable to replenish said plating bath, and said plating bath is used for plating objects, wherein a nickel complex formed of complexed nickel in said solution and/or plating bath has a pK of 1.5 or higher, and wherein said solution does not freeze, is usable to form an initial plating bath and to replenish said plating bath following storage for at least 14 days at −15 degrees Celsius.

80-81. (canceled)

82. The plating solution concentrate of claim 79, wherein said solution can be thawed after freezing and remains usable to form an initial plating bath to replenish said plating bath.

83. A plating solution concentrate for a replenishment plating process, comprising:
two or more complexers,
at least one pH adjuster; and
at least one stabilizer for stabilizing a plating reaction;
wherein said plating solution concentrate is formed in defined concentrations, is mixable with at least one of the group consisting of a nickel metal salt and a reducing agent in defined concentrations to form an initial plating solution, and wherein said initial plating solution is usable for plating objects, and wherein said initial plating solution is also usable in the same defined concentrations for replenishing said bath, wherein a nickel complex formed of complexed nickel in said plating solution concentrate, initial plating solution and/or plating bath has a pK of 1.5 or higher and wherein said solution does not freeze and is usable to form an initial plating bath and replenishing said plating bath following storage for at least 14 days at −15 degrees Celsius.

84-85. (canceled)

86. The plating solution concentrate of claim 83, wherein said solution can be thawed after freezing and remain usable to form an initial plating bath to replenish said plating bath.

87. (canceled)

88. The plating solution concentrate of claim 68, wherein said stabilizer is free of lead.

89. The plating solution concentrate of claim 68, wherein said pH adjuster is limited to an ammonium compound.

90. The plating solution concentrate of claim 88, wherein said pH adjuster is limited to ammonium hydroxide.

91. The plating solution concentrate of claim 68, wherein said pH adjuster is limited to a carbonate compound.

92. The plating solution concentrate of claim 68, wherein said solution is stable as packaged following storage for at least 14 days at at least 60 degrees Celsius and is usable to form a plating bath and to replenish said plating bath, where stability is defined as the solution concentrate will not precipitate, dissociate, or otherwise adversely react while in storage.

93. The plating solution concentrate of claim 68, wherein articles plated in said plating bath are compliant with Restriction of Hazardous Substance Directive (RoHS), Directive on Waste Electrical and Electronic Equipment (WEEE), End of Life Vehicle Directive (ELV), Registration, Evaluation, Authorisation, and Restriction of Chemicals (REACH), and similar regulations.

94. The plating solution concentrate of claim 68, wherein the pH of said solution concentrate is matched to said defined pH range.
